(19) United States
(12) Patent Application Publication
(10) Pub. No.: US 2023/0072691 A1
(43) Pub. Date: Mar. 9, 2023

(54) PIPE COATING REMOVAL APPARATUS

(71) Applicant: Decom Engineering Ltd, Cookstown, County Tyrone (GB)

(72) Inventors: Sean CONWAY, Cookstown (GB); James CONWAY, Cookstown (GB)

(21) Appl. No.: 17/799,067

(22) PCT Filed: Feb. 11, 2021
(86) PCT No.: PCT/EP2021/025051

§ 371 Date: Aug. 11, 2022

(30) Foreign Application Priority Data
Feb. 11, 2020 (GB) 2001851.1

(51) Int. Cl. B08B 9/043; B08B 1/00; B08B 9/023; B23D 79/06; B23P 23/02; B23P 23/06; B24B 21/00; B24B 21/02; B24B 27/00; B24B 27/033; B24B 27/06; B24B 29/00; B24B 29/08; B24B 49/14; B24B 49/16; B24B 5/22; B24B 55/06; B24C 1/08; B26D 3/08; B26D 3/28; F16L 55/18

(52) U.S. Cl. CPC B08B 9/0436; B08B 1/008; B08B 9/023; B08B 9/0433; B23D 79/06; B23P 23/02; B23P 23/06; B24B 21/006; B24B 21/02; B24B 27/0076; B24B 27/033; B24B 27/0616; B24B 29/005; B24B 29/08; B24B 49/14; B24B 49/16; B24B 5/22; B24B 55/06; B24C 1/086; B26D 3/08; B26D 3/282; F16L 55/18; B29B 2017/0217

(57) ABSTRACT

A pipe coating removal apparatus (1) for removing all or some of the coating on a pipe, the pipe coating removal apparatus (1) having a pipe support means (2) for supporting a length of pipe. and further having a tool carriage (3). The tool carriage (3) being capable of supporting two or more different types of pipe coating removal tools (4), (5), (6), (7), (8), (80), (81), (82) and/or (70). The pipe coating removal apparatus (1) being capable of causing relative movement between the tool carriage (3) and the pipe support means (2) to remove all or some of the coating on the pipe that is supportable by the pipe support means (2).

The present invention relates to an apparatus and method for pipe reconditioning. In particular, the present invention relates to an apparatus and method for removing various coatings from a pipe.

The production process for steel pipes typically involves passing raw material through a furnace powered by a carbon-rich substance such as coal or its derivative coke. Therefore, the production process for new steel pipes has a considerable carbon footprint. However, high grade steel pipes such as those used in the oil and gas industry typically have a pipe life of 15-20 years and are therefore very valuable and may be reused for other purposes, thereby reducing the need to produce more new pipes.

In order to maintain the integrity of pipes and prevent damage or corrosion, the pipes are coated with a protective layer of material before they are installed. Such coating material includes fusion bonded epoxy (FBE), three layer polyethylene/propylene (3LPE) or coal tar enamel (CTE). In order to reuse the pipe, the protective layer of coating must be removed so that the pipe can be inspected, welded (as you cannot weld on top of a coating) and authorized for reuse or recoating.

Most existing systems for removing these layers of protective coating such as pressure water jet systems, shot blasting systems and heat treatment systems are labour intensive and not cost effective. Furthermore, epoxy resins in FBE contain toxic chemicals and carcinogens. Applying heat or pressure to the FBE can result in airborne particles of these toxic chemicals. This can result in a variety of health defects and irritation if exposed to humans as well as negative environmental effects. Alternatively, existing systems using other mechanical means to remove the coating are time consuming and typically require multiple repeats of the process to sufficiently remove the coating from the pipe which is not energy efficient. Furthermore, these processes can also damage the integrity of the pipe which means its' value is dramatically reduced as it can only be re-purposed as scrap steel.

It is therefore an object of the present invention to mitigate the above-mentioned problems associated with pipe coating removal.

It is also an object of the invention to provide an apparatus to aid in removing coating from a pipe.

It is also an object of the present invention to provide a method for removing coating from a pipe.

According to a first aspect of the invention, there is provided a pipe coating removal apparatus for removing all or some of the coating on a pipe, the pipe coating removal apparatus comprising a pipe support means for supporting a length of pipe, and a tool carriage, the tool carriage being capable of supporting two or more different types of pipe coating removal tools, the pipe coating removal apparatus being capable of causing relative movement between the tool carriage and the pipe support means to remove all or some of the coating on a pipe that is supportable by the pipe support means.

By different tool types we mean that the different types of pipe coating removal tools are operable to remove pipe coating in a different way, such as scraping, sanding, wire brushing, shot blasting. high pressure water jet, heat treatment, chemical treatment, laser removal, cutting or abrasion.

Ideally, the two or more different types of pipe coating removal tools comprises any two of a scraping tool, a cutting tool and/or an abrasive tool.

Advantageously, a pipe can be set on the pipe support means and the tool carriage and the tools of the tool carriage can be operated to remove the coating of a pipe. Using different tool types, such as scraping tools, cutting tools, and/or abrasive tools ensures an expedient and even removal of the coating.

Ideally, the pipe coating removal apparatus is capable of removing all or some of the coating along the entire length of the pipe.

Preferably, the pipe coating removal apparatus is configurable to rotate a pipe supportable by the pipe support means.

Preferably, the pipe coating removal apparatus is a driven and/or powered apparatus.

Preferably, the pipe coating removal apparatus is electrically, hydraulically and/or otherwise suitably powered.

Ideally, the pipe coating removal apparatus is powered by diesel, electric and/or is a hybrid apparatus.

Ideally, the pipe coating removal apparatus comprises a diesel generator. Preferably, the pipe coating removal apparatus comprises drive means for driving one or more component parts of the pipe coating removal apparatus.

Ideally, the drive means is electrically, hydraulically and/or otherwise suitably powered.

Ideally, the drive means is powered by diesel, electric and/or is a hybrid drive means.

Ideally, the pipe coating removal apparatus comprises at least one electric motor.

Ideally, the pipe coating removal apparatus comprises at least one hydraulic motor.

Ideally, the pipe coating removal apparatus comprises a hydraulic fluid storage means.

Ideally, the tool carriage comprises a hydraulic fluid storage means.

Preferably, the hydraulic fluid storage means is a tank.

Preferably, the tool carriage is configurable to support a plurality of tools for removing pipe coating from a pipe.

Preferably, the tool carriage is configurable to support at least two tools.

Ideally, the tool carriage being configurable to support at least three tools.

Preferably, the tool carriage is configurable to support at least eight tools.

Preferably, the two or more pipe coating removal tools are releasably attachable to the tool carriage.

Preferably, the at least eight tools are releasably attachable to the tool carriage.

Preferably, the two or more pipe coating removal tools are releasably attachable to the tool carriage via one or more mechanical fasteners such as screws, bolts, pins and/or any other suitable means.

Preferably, the at least eight tools are releasably attachable to the tool carriage via one or more mechanical fasteners such as screws, bolts, pins and/or any other suitable means.

Preferably, the location and/or type of tools are interchangeable on the tool carriage.

Advantageously, bespoke tool carriages can be easily formed for different pipe coating removal tasks.

Preferably, the tool carriage supports a tool frame.

Ideally, the tool carriage supports at least three tool holders.

Ideally, the tool frame supports at least three tool holders.

Ideally, the tool carriage supports at least eight tool holders.

Ideally, the tool frame supports at least eight tool holders.

Preferably, the two or more pipe coating removal tools are releasably attachable to the tool holders.

Preferably, the two or more pipe coating removal tools are releasably attachable to the tool holders via one or more mechanical fasteners such as screws, bolts, pins and/or any other suitable means.

Ideally, only one tool is attached to each tool holder at any one time.

Preferably, the tool carriage is constructed from steel, metal or metal alloy.

Ideally, the tool carriage may be constructed from any other suitable material.

Advantageously, constructing the tool carriage from steel, metal, metal alloy or any other suitable material provides a strong support for the tool frame and the at least three tool holders.

Preferably, the pipe support means comprises a framework for supporting the pipe and/or guiding movement of the tool carriage.

Preferably, the framework is formed of two spaced apart, parallel beams.

Ideally, the beams are I-section beams, most preferably being formed from steel and/or another suitable metal.

Preferably, the framework comprises reinforcements to secure the beams together.

Preferably, the reinforcements comprise one or more cross members extending between the beams.

Ideally, the framework is supported off the ground by one or more supports.

Preferably, the framework is supported off the ground by at least one leg.

Advantageously, this enables sufficient room for other elements of the pipe coating removal apparatus to operate.

Preferably the tool carriage is supportable on the pipe support means.

Preferably, the pipe coating removal apparatus comprises a tool carriage structural support frame.

Preferably, the tool carriage structural support frame extends upright from one of the spaced apart parallel beams of the pipe support means.

Preferably, the tool carriage structural support frame extends across the pipe support means towards the other spaced apart parallel beam.

Preferably, the structural support frame is an inverted U shape.

Preferably, the tool carriage structural support frame comprises an inverted U shaped main frame.

Preferably, the tool carriage structural support frame extends upright from both of the spaced apart parallel beams and across the pipe support means.

Preferably, the tool carriage structural support frame extends upright from both of the spaced apart parallel beams and across the pipe support means to form an enclosure over at least part of the pipe support means.

Preferably, the tool carriage structural support frame extends upright from both of the spaced apart parallel beams and across the pipe support means to form an enclosure over at least part of a pipe supportable on the pipe support means.

Preferably, the tool carriage structural support frame comprises a plurality of stanchions, bars, beams posts and/or any other suitable structural means configurable to form a support frame.

Preferably, the plurality of stanchions, bars, beams posts and/or any other suitable structural means configurable to form a support frame extend upright from one or both of the spaced apart parallel beams and across the pipe support means to create a roof structure.

Preferably, the tool carriage structural support frame is configurable to support the tool carriage, the hydraulic fluid storage means and/or one or more other component parts of the pipe coating removal apparatus.

Preferably, the tool carriage structural support frame is configurable to support approximately 20 tonnes of weight.

Preferably, the tool carriage structural support frame is configurable to support at least 20 tonnes of weight.

Preferably, the tool carriage structural support frame comprises one or more platforms configurable to support one or more other components of the pipe coating removal apparatus.

Ideally, the one or more platforms extend laterally from the inverted U shaped main frame of the tool carriage structural support frame.

Preferably the tool carriage is moveable along the pipe support means.

Preferably, the tool carriage is moveable along the spaced apart parallel beams of the pipe support means.

Preferably, the pipe coating removal apparatus comprises a tool carriage drive means configurable to cause movement of the tool carriage along the pipe support means.

Preferably, the tool carriage drive means comprises a plurality of wheels, guides, racks, rails and/or any other suitable means configurable to cause movement of the tool carriage along the pipe support means.

Preferably, the tool carriage drive means comprises two or more gear wheels locatable on the tool carriage structural support frame.

Preferably, the tool carriage drive means comprises a two or more gear plates.

Preferably, each of the spaced apart parallel beams of the structural support means comprises a gear plate.

Preferably, at least one of the gear wheels engages with a gear plate of one of the spaced apart parallel beams and at least one of the gear wheels engages with the gear plate of the other spaced apart parallel beams.

Preferably, the two or more gear wheels comprises a plurality of radially projecting teeth.

Preferably, the two or more gear plates comprise a plurality of upwardly projecting teeth.

Preferably, the plurality of teeth of the two or more gear wheels are configurable to slot between the plurality of teeth of the two or more gear plates forming a rack and pinion drive assembly.

Preferably, the tool carriage drive means is electrically, hydraulically and/or otherwise suitably powered.

Ideally, the tool carriage drive means is powered by diesel, electric and/or is hybrid driven.

Preferably, the tool carriage drive means comprises one or more motors configurable to drive movement of the tool carriage along the pipe support means.

Preferably, the pipe coating removal apparatus comprises one or more electric motors configurable to drive movement of the tool carriage along the pipe support means.

Preferably, the tool carriage drive means comprises one or more electric motors configurable to drive movement of the tool carriage along the pipe support means. Alternatively, or additionally, the tool carriage drive means may comprise a hydraulic motor and/or any other suitable motor configurable to drive movement of the tool carriage along the pipe support means.

Preferably, the pipe coating removal apparatus comprises a tool carriage guide means configurable to guide linear movement of the tool carriage over the pipe support means.

Preferably, the tool carriage drive means comprises a tool carriage guide means configurable to guide linear movement of the tool carriage over the pipe support means.

Preferably, the tool carriage guide means is configurable to prevent slippage of the tool carriage off the pipe support means.

Preferably, the tool carriage guide means is configurable to maintain engagement of the tool carriage with the pipe support means.

Preferably, the tool carriage guide means comprises a plurality of wheels, guides, rails and/or any other suitable means configurable to guide linear movement of the tool carriage along the pipe support means.

Preferably, the tool carriage guide means comprises two or more carriage wheels locatable on the tool carriage support frame.

Preferably, the tool carriage guide means comprises two or more carriage rails.

Preferably, each of the spaced apart parallel beams of the structural support means comprises a carriage rail.

Preferably, the carriage rail on each of the spaced apart parallel beams is parallel to the gear plate on that spaced apparat parallel beam.

Preferably, at least one of the carriage wheels engages with carriage rail of one of the spaced apart parallel beams and at least one of the carriage wheels engages with the carriage rail of the other spaced apart parallel beams.

Preferably, the two or more carriage wheels comprise a two circumferentially extending flanges and a groove which extends between the two circumferentially extending flanges.

Preferably, the two or more carriage rails extend outwardly from the spaced apart parallel beams.

Preferably, the two or more carriage rails extend upwardly from the spaced apart parallel beams.

Preferably, each of the carriage rails extend into the groove of the at least one engaging carriage wheel, between the circumferentially extending flanges to guide linear movement of the tool carriage.

Preferably, the tool carriage is moveable over a pipe that is supportable on the pipe support means.

Preferably, the tool carriage is configurable to move alongside a pipe that is supportable on the pipe support means.

Ideally, the tool carriage drive means is operable to power movement of the tool carriage.

Advantageously, moving the tool carriage over a pipe that is supportable on the pipe support means enables engagement of the pipe coating removal apparatus with the outer diameter of the pipe.

Further advantageously, moving the tool carriage over a pipe that is supportable on the pipe support means reduces the space occupied by the pipe coating removal apparatus and the amount of material required to manufacture the pipe coating removal apparatus. Some prior art pipe coating removal apparatuses operate by moving the pipe through a static tool carriage. The pipe support surface in such apparatuses is therefore required to be at least twice the length of the pipe.

Alternatively, the tool carriage is a static tool carriage.

Preferably, the hood and/or roof structure of the tool carriage is configurable to protect the tools from external damage such as inclement weather conditions.

Advantageously, protecting the tools from external damage reduces wear and tear of tools.

Preferably, the hood and/or roof structure is configurable to extend over a pipe supportable on the pipe support means.

Preferably, when a pipe is supported on the pipe support means, the hood and/or roof structure extends over the pipe.

Preferably, the tool frame is mounted on the tool carriage.

Preferably, the tool frame is mounted on the tool carriage structural support frame.

Preferably, the tool frame is mounted on the tool carriage and/or tool carriage structural support frame via one or more mechanical fasteners such as screws, bolts, pins and/or any other suitable means.

Preferably, the position of the tool frame can be adjusted relative to the pipe support means.

Ideally, the position of the tool frame can be raised and lowered relative to the pipe support means.

Advantageously, adjustment of the tool frame enables the pipe coating removal apparatus to accommodate different sizes of pipe diameter.

Preferably, the position of the tool frame is slidably adjustable.

Ideally, the tool frame is mounted on the tool carriage and/or tool carriage structural support frame via one or more linear rails.

Preferably, the pipe coating removal apparatus comprises one or more hydraulic rams for actuating movement of the tool frame.

Preferably, the pipe coating removal apparatus comprises one or more hydraulic rams for raising and/or lowering the tool frame.

Preferably, the tool carriage is weighted to reduce vibration of the pipe coating removal apparatus.

Advantageously, reducing vibration of the pipe coating removal apparatus maintains a smooth engagement of the pipe coating removal apparatus with the pipe and reduces wear and tear of the pipe coating removal apparatus.

Preferably, each of the two or more pipe coating removal tools comprise a tool arm.

Ideally, the tool arm of each of the two or more pipe coating removal tools is releasably attachable to the tool carriage and/or tool frame and/or tool holders.

Preferably, the tool arm is releasably attachable to the tool carriage and/or tool frame and/or tool holders via a pin.

Preferably, the tool arm is configurable to pivot around the longitudinal axis of the pin.

Preferably, the tool arm is configurable to be raised and/or lowered via pivoting around the longitudinal axis of the pin.

Preferably, the tool arm of each of the two or more pipe coating removal tools extends from the portion of the tool carriage and/or tool frame and/or tool holder to which it is attached.

Preferably, the tool arm of each of the two or more pipe coating removal tools extends outwardly from the portion of the tool carriage and/or tool frame and/or tool holder to which it is attached.

Preferably, each of the two or more pipe coating removal tools comprise a tool head.

Preferably, the tool head is configurable to be raised and/or lowered.

Preferably, the tool head is configurable to be raised and/or lowered via a hydraulic and/or pneumatic cylinder.

Preferably, the hydraulic and/or pneumatic cylinder is attached to the tool carriage and/or tool frame and/or tool holder at one end and to the tool head at the other end.

Preferably, the tool head extends from the tool arm.

Preferably, at least a portion of the tool head engages with the coating on a pipe supportable by the pipe support means to remove that coating.

Preferably, the tool head is configurable to remove all or some of the pipe coating on a pipe supportable by on the pipe support means.

Preferably, the tool head comprises means for removing all or some of the pipe coating on a pipe supportable by the pipe support means.

Preferably, the tool head comprises a blade, a brush, abrasive material and/or any other means suitable for removing all or some of the pipe coating on a pipe supportable by the pipe support means.

Preferably, the pipe coating removal apparatus comprises a longitudinal cutting tool to create a longitudinal cut along the pipe coating.

Advantageously, preforming a longitudinal cut on the coating along the length of a pipe, prior to rotating the pipe, results in small rings of coating being removed thereby preventing long lengths of coiled waste coating gathering on the pipe coating removal apparatus.

Preferably, the longitudinal cutting tool comprises a blade.

Preferably, the longitudinal cutting tool is configurable to work in both longitudinal directions allowing the pipe coating removal tool to operate from either end of a pipe supportable on the pipe support means.

Ideally, the blade is double acting.

Ideally, the blade is double edged.

Advantageously, the longitudinal cutting tool can work in both longitudinal directions allowing the pipe coating removal tool to operate from either end of the pipe.

Preferably, the blade is locatable on the tool head of the longitudinal cutting tool.

Preferably, the pipe coating removal apparatus comprises a circumferential scraping tool.

Advantageously, performing a circumferential scrape removes coating on the pipe as the pipe is being rotated.

Preferably, the circumferential scraping tool comprises a scraping blade.

Ideally, the scraping blade is locatable on the tool head of the circumferential scraping tool.

Preferably, the circumferential scraping tool is configurable to removes all or some coating on a pipe supportable on the pipe support means.

Preferably, the circumferential scraping tool is configurable to removes all or some coating on a pipe supportable on the pipe support means as the pipe is being rotated.

Ideally, the circumferential scraping tool removes all or some coating on a pipe supportable on the pipe support means, most preferably, the circumferential scraping tool removes all or some polyethylene coating.

Preferably, the one or more abrasive tools comprise brushes, most preferably wire brushes.

Preferably, the pipe coating removal apparatus comprises a plurality of abrasive tools.

Preferably, the plurality of abrasive tools comprises one or more wire brushes.

Preferably, the one or more wire brushes are single head brushes and/or double head wire brushes.

Advantageously, the brushes enable removal of residual particles of coating and adhesive from weld pockets.

Preferably, the one or more wire brushes are configurable to be angled transversely to the tool arm and/or angled such that is it paralell with the tool arm.

Preferably, the tool head of the one or more wire brushes are configurable to be angled transversely to the tool arm and/or angled such that is it parallel with the tool arm.

Ideally, the one or more wire brushes are configurable to be angled transversely to the longitudinal axis of a pipe supportable on the pipe support means.

Ideally, the tool head of the one or more wire brushes are configurable to be angled transversely to the longitudinal axis of a pipe supportable on the pipe support means.

Ideally, the one or more wire brushes are configurable to be angled such that it is parallel with the longitudinal axis of a pipe supportable on the pipe support means.

Ideally, the tool head of the one or more wire brushes are configurable to be angled such that it is parallel with the longitudinal axis of a pipe supportable on the pipe support means.

Preferably, when there are two or more wire brushes, at least one of the wire brushes is configurable to be angled transversely to the tool arm and at least one of the wire brushes is configurable to be angled such that it is parallel with the tool arm.

Preferably, when there are two or more wire brushes, the tool head of at least one of the wire brushes is configurable to be angled transversely to the tool arm and the tool head of at least one is configurable to be angled such that it is parallel with the tool arm.

Preferably, when there are two or more wire brushes, at least one of the wire brushes is configurable to be angled transversely to the longitudinal axis of a pipe supportable on the pipe support means and at least one is configurable to be angled such that it is parallel with the longitudinal axis of a pipe supportable on the pipe support means.

Preferably, the one or more brushes are configurable to be angled such that the main plane of rotation of the one or more brushes is transverse to the longitudinal axis of a pipe supportable on the pipe support means.

Preferably, the tool head of the one or more brushes are configurable to be angled such that the main plane of rotation of the one or more brushes is transverse to the longitudinal axis of a pipe supportable on the pipe support means.

Preferably, the one or more brushes are configurable to be angled such that the main plane of rotation of the one or more brushes is perpendicular to the longitudinal axis of a pipe supportable on the pipe support means.

Preferably, the tool head of the one or more brushes are configurable to be angled such that the main plane of rotation of the one or more brushes is perpendicular to the longitudinal axis of a pipe supportable on the pipe support means.

Preferably, the one or more brushes are configurable to be angled such that the main plane of rotation of the one or more brushes is parallel with the longitudinal axis of a pipe supportable on the pipe support means.

Preferably, the tool head of the one or more brushes are configurable to be angled such that the main plane of rotation of the one or more brushes is parallel with the longitudinal axis of a pipe supportable on the pipe support means.

Preferably, when there are two or more brushes, at least one of the brushes is angled transversely relative to at least one of the other brushes.

Preferably, when there are two or more brushes, the tool head of at least one of the brushes is angled transversely relative to the tool head of at least one of the other brushes.

Preferably, when there are two or more brushes, at least one of the brushes is angled perpendicular relative to at least one of the other brushes.

Preferably, when there are two or more brushes, the tool head of at least one of the brushes is angled perpendicular relative to the tool head of at least one of the other brushes.

Advantageously, having the brushes at different angles enables the brushes to scrub into different types of pockets and/or welds to remove coating from these areas.

Ideally, the brushes remove all or some coating on a pipe supportable on the pipe coating removal apparatus, most preferably, the brushes remove all or some polyethylene glue coating.

Alternatively, or additionally, the one or more abrasive tools comprise a one or more abrasive flap wheel tools.

Preferably, the one or more abrasive flap wheel tools comprise multiple sheets of abrasive material bonded to a central shaft.

Preferably, the size, grit, diameter, and width of the one or more flap wheel tools is adjustable.

Preferably, the one or more flap wheel tools are of varying grit.

Preferably, the one or more flap wheel tools comprises a pneumatic cylinder which enables the flap wheel tools to be raised and lowered towards and/or away from a pipe supportable on the pipe support means.

Preferably, the one or more flap wheel tools are powered by a hydraulic motor.

Alternatively, or additionally, the one or more abrasive tools comprise sanding tools, most preferably belt sanders.

Advantageously, using sanding tools ensures removal of any remaining coating or adhesive and creates a smooth finish on the pipe.

Preferably, the sanding tools remove all or some coating on a pipe supportable on the pipe coating removal apparatus, most preferably, the sanding tools remove all or some fusion bonded epoxy coating.

Preferably, the belt sanders can be adjusted according to belt grip requirements and/or the grit type required.

Preferably, the torque, RPM, pitch, sharpness, material type and/or abrasiveness of the one or more abrasive tools are adjustable.

Advantageously, adjustment of the torque, RPM, pitch, sharpness, material type and abrasiveness of the one or more abrasive tools enables the pipe coating removal apparatus to effectively remove pipe coating as required without damaging the pipe.

Preferably, the pipe coating apparatus comprises a plurality of belt sanders having varying grit.

Preferably, the two or more pipe coating removal tools are arrangeable adjacent to one another.

Preferably, the two or more pipe coating removal tools are arrangeable adjacent to one another along at least part of the length of the pipe coating removal apparatus.

Preferably, the two or more pipe coating removal tools are arrangeable adjacent to one another along at least part of the length of the tool carriage.

Preferably, the two or more pipe coating removal tools are arranged in series.

Ideally, the cutting tool(s), scraping tool(s) and/or abrasive tool(s) are electrically, hydraulically, pneumatically or any other way suitably powered.

Ideally, the cutting tool(s), scraping tool(s) and/or abrasive tool(s) are powered by diesel, electric and/or is hybrid driven.

Ideally, the cutting tool(s), scraping tool(s) and/or abrasive tool(s) comprise at least one hydraulic and/or pneumatic cylinder.

Preferably, the at least one hydraulic and/or pneumatic cylinder is configurable to raise and/or lower the cutting tool(s), scraping tool(s) and/or abrasive tool(s) towards and/or away from a pipe supportable on the pipe support means.

Preferably, the cutting tool(s), scraping tool(s) and/or abrasive tool(s) are configurable to be operated independently.

Ideally, the cutting tool(s), scraping tool(s) and/or abrasive tool(s) have an independent actuator for actuating the tools independently and/or simultaneously.

Preferably, the tools are configurable to be raised and/or lowered towards and/or away from a pipe. which is supportable on the pipe support means, in use.

Advantageously, having an independent actuator for the cutting tool(s), scraping tool(s) and/or abrasive tool(s) allows the cutting tool(s), scraping tool(s) and/or abrasive tool(s) to be operated at the same time or independently when required.

Ideally, the cutting tool(s), scraping tool(s) and/or abrasive tool(s) are configurable to operated simultaneously, in use.

Preferably, independent actuators for the cutting tool(s), scraping tool(s) and/or abrasive tool(s) are configurable to operated separately, in use.

Preferably, the pipe coating removal apparatus comprises heat treatment means for removing coating from a pipe via heat treatment.

Preferably, the pipe coating removal apparatus comprises a laser tool for removing coating from a pipe via heat treatment.

Preferably, the pipe coating removal apparatus comprises chemical treatment means for removing coating from a pipe via chemical treatment.

Preferably, the pipe coating removal apparatus comprises a guide means to guide engagement of at least one of the two or more pipe coating removal tools with a surface of a pipe supportable on the pipe support means.

Preferably, the pipe coating removal apparatus comprises a guide means to guide engagement of at least one of the two or more pipe coating removal tools with a pipe coating on a surface of a pipe supportable on the pipe support means, as the tool removes the pipe coating.

Preferably, at least one of the two or more pipe coating removal tools comprise a guide means to guide engagement of that tools with a surface of a pipe supportable on the pipe support means.

Preferably, at least one of the two or more pipe coating removal tools comprises a guide means to guide engagement of that tool with a pipe coating on a surface of a pipe supportable on the pipe support means, as the tool removes the pipe coating.

Preferably, the guide means is releasably attachable to the two or more pipe coating removal tools.

Preferably, the guide means is releasably attachable to at least one of the two or more pipe coating removal tools.

Preferably, the guide means is releasably attachable to the at least eight tools.

Preferably, the guide means is releasably attachable to a portion of the two or more pipe coating removal tools.

Preferably, the guide means is releasably attachable to the tool arm of the two or more pipe coating removal tools.

Preferably, the guide means is releasably attachable to a side portion of the tool arm of the two or more pipe coating removal tools.

Preferably, the guide means is releasably attachable to an underside portion of the tool arm of the two or more pipe coating removal tools.

Preferably, the guide means comprises a guide roller.

Preferably, the guide means is configurable to engage with the external surface of a pipe supportable on the pipe support means.

Preferably, the guide roller is configurable to engage with the external surface of a pipe supportable on the pipe support means.

Preferably, the guide means is configurable to engage with the external surface of a pipe supportable on the pipe support means, as the pipe rotates.

Preferably, the guide roller is configurable to engage with the external surface of a pipe supportable on the pipe support means, as the pipe rotates.

Preferably, the guide roller is rotatable.

Preferably, the guide roller is configurable to engage with the external surface of a pipe and rotate in response to rotation of the pipe.

Preferably, the guide roller is rotatable via rotation of a pipe supportable on the pipe support means.

Advantageously, this prevents friction between the guide roller and the pipe.

Preferably, the guide roller is configurable to maintain engagement with the external surface of a pipe supportable on the pipe support means as the pipe rotates.

Preferably, the guide roller is configurable to follow the contour of a pipe supportable on the pipe support means.

Preferably, the guide means is configurable to cause the tool head of the at least one tool to follow the contour of a pipe supportable on the pipe support means.

Preferably, the guide roller is configurable to ride over any welds and/or dents on the external surface of a pipe supportable on the pipe support means while maintaining engagement with the external surface of the pipe.

Preferably, the guide means is configurable to raise and/or lower depending on the contour of a pipe supportable on the pipe support means.

Preferably, the guide means is configurable to move radially towards and/or away from a pipe supportable on the pipe support means depending on the contour of that pipe.

Preferably, the guide means is configurable to move radially towards and/or away from the longitudinal axis of a pipe supportable on the pipe support means depending on the contour of that pipe.

Preferably, the guide means is configurable to cause the tool head of the at least one tool to move radially towards and/or away from a pipe supportable on the pipe support means depending on the contour of that pipe.

Preferably, the guide means is configurable to cause the tool head of the at least one tool to move radially towards and/or away from the longitudinal axis of a pipe supportable on the pipe support means depending on the contour of that pipe.

Preferably, the guide means is configurable to control the distance of the tool head of the at least one tool relative to the external surface of a pipe supportable on the pipe support means.

Preferably, the guide means is configurable to adjust the distance of the tool head of the at least one tool relative to the external surface of a pipe supportable on the pipe support means.

Preferably, the guide means is configurable to raise and/or lower the tool head of the at least one tool relative to the external surface of a pipe supportable on the pipe support means.

Preferably, the guide means is configurable to raise and/or lower the tool head of the at least one tool depending on the contour of the pipe supportable on the pipe support means.

Preferably, attachment of the guide means to the at least one tool enables the guide means to adjust the height of the tool head of that tool depending on the contour of the pipe supportable on the pipe support means.

Preferably, the guide means is configurable to adjust the height of the tool head in response to deformations such as welds and/or protrusions on the external surface of a pipe supportable on the pipe support means.

Preferably, the guide means is configurable to raise the height of the tool head in response to deformations such as welds and/or protrusions on the external surface of a pipe supportable on the pipe support means.

Advantageously, this prevents the tool head digging into the external surface of the pipe and potentially causing damage to the pipe.

Preferably, the guide means is configurable to adjust the height of the tool head in response to deformations such as dents on the external surface of a pipe supportable on the pipe support means.

Preferably, the guide means is configurable to lower the height of the tool head in response to deformations such as dents on the external surface of a pipe supportable on the pipe support means.

Advantageously, this prevents the tool head from coming out of engagement with the coating on the external surface of the pipe. Thereby, this ensures uniform removal of the coating from the external surface of the pipe.

Preferably, the guide means maintains optimum height of the tool head to enable as much coating as possible to be removed from the external surface of a pipe supportable on the pipe support means, without damaging the pipe.

Preferably, the guide means maintains optimum distance of the tool head relative to a pipe supportable on the pipe support means to enable as much coating as possible to be removed from the external surface of the pipe, without damaging the pipe.

Preferably, the guide roller engages with an uncoated surface of a pipe supportable on the pipe support means.

Preferably, the guide roller is disposed laterally from the tool head of the at least one tool.

Preferably, the distance of the guide roller in relation to the external surface of a pipe supportable on the pipe support means is the same as the distance of the tool head of the at least one tool in relation to the external surface of a pipe supportable on the pipe support means.

Preferably, the guide roller is configurable to be positioned ahead of the blade and/or brush and/or tool head of the at least one tool such that the guide roller engages with any deformations on the external surface of a pipe supportable on the pipe support means before the tool engages with the deformation.

Preferably, the guide roller is configurable to be positioned ahead of the blade and/or brush and/or tool head of the at least one tool such that the guide roller is subject to any deformations on the external surface of a pipe supportable on the pipe support means before the tool is subject to the deformation.

Preferably, the guide roller precedes the blade and/or brush and/or tool head of the at least one tool so that movement of the guide roller due to the contours of a pipe supportable on the pipe support means is followed by the blade and/or brush and/or tool head.

Preferably, the height and/or pitch of the guide roller can be adjusted.

Preferably, the height and/or pitch of the guide roller can be manually adjusted.

Preferably, the height and/or pitch of the guide roller can be remotely adjusted.

Preferably, the guide means comprises an adjustable guide roller arm configurable to enable adjustment of the guide roller.

Advantageously, adjustment of the of the height and/or pitch of the guide roller accommodates for different depth requirements based on blade/brush/tool head wear of the tool and/or the depth of the coating of a pipe supportable on the pipe support means.

Preferably, the adjustable guide roller arm is a telescopic arm.

Advantageously, this enables the length of the guide roller arm to be adjusted and therefore enables the position of the guide roller to be adjusted.

Preferably, the adjustable guide roller arm comprises two or more telescopic members configurable to slide into and out of one another to enable length adjustment of the adjustable guide roller arm.

Preferably, the guide means comprises a link arm for attaching the guide means to the at least one tool.

Preferably, the link arm is an adjustable link arm.

Preferably, the link arm is attached to the guide roller arm at one end via a pin and to the tool head at the other end via a pin.

Preferably, the adjustable guide roller arm is configurable to pivot about the longitudinal axis of the pin attaching it to the guide link arm.

Preferably, the guide link arm is configurable to pivot around the longitudinal axis of one or both of the pins attaching it to the adjustable guide roller arm and the tool head.

Preferably, adjustment of the length of the adjustable guide roller arm will cause the adjustable guide roller arm and/or the link arm to pivot along the longitudinal axis of the pin attaching the adjustable guide roller arm to the link arm to accommodate for the length adjustment of the adjustable guide roller arm.

Ideally, adjustment of the length of the adjustable guide roller arm will cause the link arm and/or the tool head to pivot along the longitudinal axis of the pin attaching the link arm to the tool head to accommodate for the length adjustment of the adjustable guide roller arm.

Preferably, the guide means comprises a locking means to prevent undesirable movement of the adjustable guide roller arm.

Preferably, the guide means comprises a locking means to prevent undesirable adjustment to the length of the adjustable guide roller arm.

Preferably, the guide means comprises an adjustable guide roller arm clamp to prevent undesirable movement of the adjustable guide roller arm.

Preferably, the guide means comprises an adjustable guide roller arm clamp undesirable adjustment to the length of the adjustable guide roller arm.

Preferably, the adjustable guide roller arm clamp is configurable to releasably clamp the adjustable guide roller arm in position.

Preferably, the adjustable guide roller arm clamp can be released to enable adjustment of the adjustable guide roller arm.

Preferably, the adjustable guide roller arm clamp is a clamp, screw, bolt and/or any other means suitable to releasably fasten to prevent movement of the adjustable guide roller arm.

Preferably, the adjustable guide roller arm clamp is a clamp, screw, bold and/or any other means suitable to releasably fasten to prevent movement of the two or more telescopic members of the adjustable guide roller arm.

Preferably, the guide link arm is a turn buckle.

Preferably, the guide means comprises a guide chute configurable to guide removed pipe coating away from the tool head.

Preferably, the tool arm comprises a guide chute configurable to guide removed pipe coating away from the tool head.

The guide chute comprises a deflection surface which is configurable to engage with and deflect removed pipe coating away from the tool head and/or tool frame.

Preferably, the guide chute is locatable behind the tool head.

Preferably, the pipe coating removal apparatus comprises a shock absorber to absorb any shock from height spots and/or deformations when processing the pipe.

Preferably, the guide means comprises a shock absorber to absorb any shock from height spots and/or deformations when processing the pipe.

Preferably, the shock absorber is a hydraulic accumulator.

Preferably, the at least one circumferential scraping tool comprises a guide means.

Preferably, the guide means is configurable to control the height of the scraping blade of the at least one scraping tool in relation to the external surface of a pipe which is supportable on the pipe support means.

Preferably, in one embodiment, the pipe coating removal apparatus comprises multiple tool carriages.

Ideally, the pipe coating removal apparatus comprises a control means for controlling one or more components of the pipe coating removal apparatus.

Ideally, the pipe coating removal apparatus comprises a control means for controlling one or more components of the pipe coating removal apparatus such as one or more valves, pumps and/or any other suitable control means which may be activated and/or deactivated via one or more levers, buttons, cords, remote radio control and/or any other suitable activation or deactivation trigger.

Ideally, the pipe coating removal apparatus comprises a control panel for operating the control means and/or one or more components of the pipe coating removal apparatus.

Preferably, the pipe coating removal apparatus comprises a cabin for an operator.

Preferably, the cabin is a control cabin for an operator.

Ideally, the control panel being locatable within the cabin.

Advantageously, controlling the pipe coating removal apparatus from the cabin reduces the risk of injury to operators in comparison to some prior art where the removal means are brought into engagement with the pipe manually or where the controls are located next to the removal means or motors.

Further advantageously, locating the controls within the cabin increases protection to the controls against inclement weather conditions such as rain or intense heat.

Ideally, the cabin comprises a window to enable vision from the cabin.

Preferably, the cabin is locatable at a level overlooking the pipe support means.

Preferably, the cabin is locatable at a level such that the window is overlooking the pipe support means.

Preferably, the cabin is locatable at a level overlooking the pipe support means such that when a pipe is supportable on the pipe support means, the cabin is overlooking the pipe.

Preferably, the cabin is locatable at a level such that when a pipe is supportable on the pipe support means, the window of the cabin is overlooking the pipe.

Preferably, the cabin is locatable at a level overlooking a pipe when the pipe is supportable on the pipe support means.

Advantageously, locating the control cabin to overlook the pipe support means ensures the section of pipe being operated on is visible to the operator.

Preferably, the cabin is locatable at a level overlooking the tool frame and/or the two or more pipe coating removal tools.

Preferably, the cabin is locatable at a level such that the window of the cabin is overlooking the tool frame and/or the two or more pipe coating removal tools.

Preferably, the cabin mutually opposes the tool carriage.

Preferably, the cabin is supported on a platform of the tool carriage structural support frame.

Preferably, the cabin comprises a roof which connects to the hood and/or roof structure of the tool carriage structural support frame.

Ideally, the position of the tool frame can be adjusted from the control cabin.

Preferably, the height and/or pitch of the guide roller can be adjusted from the control cabin.

Alternatively, the height and/or pitch of the guide roller can be adjusted outside the control cabin.

Ideally, the pipe coating removal apparatus is configurable to remove all or some of the coating on the pipe with a single pass of the tool carriage relative to the pipe.

Preferably, the pipe support means comprises at least one contact element for contacting the surface of a pipe supportable on the pipe support means.

Preferably, the pipe support means has two or more spaced apart contact elements.

Preferably, the pipe support means comprises two or more longitudinally spaced apart contact elements.

Preferably, the two or more contact elements are moveable towards/away from one another to enable adjustment of the length over which a pipe can is supportable on the pipe support means.

Ideally, the two or more contact elements are moveable towards/away from one another on a rail.

Advantageously, adjustment of the length over which a pipe can is supportable on the pipe support means enables accommodation of different lengths of pipe.

Preferably, loading components comprise an opening through which the rail extends.

Ideally, opening is shaped to correspond to the shape of the rail.

Preferably, movement of the contact elements along the rail is via one or more hydraulic cylinders.

Preferably, movement of the two or more contact elements is automated.

Preferably, movement of the two or more contact elements is configurable to be controlled from the cabin of the pipe coating removal apparatus.

Preferably, linear movement of the two or more contact elements is automated.

Preferably, linear movement of the two or more contact elements is configurable to be controlled from the cabin of the pipe coating removal apparatus.

Preferably, the two or more contact elements comprise at least one rotator for rotating the pipe.

Preferably, each of the two or more contact elements comprise at least one rotator for rotating the pipe during operation.

Preferably, each of the two or more contact elements comprise at least one rotator for rotating the pipe during operation of the tool carriage and/or during operation of at least one of the at least 8 tools.

Preferably, each of the two or more contact elements comprise two or more rotators operably coupled to a common drive means and/or shaft.

Advantageously, fixing the two or more rotator(s) to a common shaft ensures simultaneous rotation of the two or more rotator(s).

Preferably, in use, the at least one rotator contacts the pipe and rotates the pipe about its longitudinal axis.

Advantageously, this ensures that the entire outer diameter of the pipe is exposed to the pipe coating removal apparatus without manual intervention.

Ideally, the at least one rotator is a rotatable wheel.

Ideally, the rotatable wheel is composed of a resilient material.

Preferably, the rotatable wheel is composed of rubber.

Advantageously, composing the rotatable wheel of a resilient material such as rubber reduces friction between the at least one rotator and the pipe and reduces lagging damage and/or slippage.

Preferably, the rotatable wheel comprises outer surface material configurable to provide maximum contact friction between the rotator and a pipe supportable on the pipe support means to prevent slippage during the pipe coating removal process and/or a pipe cleaning process.

Preferably, the at least one rotatable wheel is a friction wheel.

Preferably, the at least one rotatable wheel is durable.

Ideally, the at least one rotatable wheel is formed from a durable material.

Preferably, the at least one rotatable wheel is configurable to absorb shock.

Ideally, the at least one rotatable wheel is a forklift wheel.

By forklift wheel, we mean a wheel typically used on a forklift.

Preferably, the pipe support means comprises two or more spaced apart mini contact elements capable of contacting and supporting lighter pipes.

Ideally, the two or more mini contact elements comprise at least one mini rotator to rotate lighter pipes.

Ideally, the at least one mini rotator is lined with a non-damaging material such as rubber, nylon, plastic etc.

Advantageously, the two or more mini contact elements and at least one mini rotator enable the pipe coating removal apparatus to remove coating on lighter pipes without causing damage to the lighter pipes as larger rotator(s) may cause lighter pipes to bounce and become dented or scratched.

Preferably, the pipe coating removal apparatus comprises an internal rotator.

Ideally, the pipe coating removal apparatus comprises and internal rotator to rotate the pipe internally.

Ideally, the internal rotator is configurable to fit inside a pipe.

Ideally, the internal rotator is configurable to fit inside a variety of pipes having different sized diameters.

Ideally, the internal rotator is adjustable to fit inside a variety of pipes having different sized diameters.

Ideally, the internal rotator is configurable to lock onto the internal diameter of the pipe.

Ideally, the internal rotator is configurable to lock onto an insert on the pipe.

Advantageously, the internal rotator enables non frictional rotation of the pipe.

Preferably, the rotator drive means is operable to rotate the at least one rotator, at least one mini rotator and/or internal rotator.

Preferably, the rotator drive means is electrically, hydraulically and/or otherwise suitably powered.

Ideally, the rotator drive means is powered by diesel, electric and/or is hybrid driven.

Preferably, the rotator drive means comprises an inverter to control variable speed.

Advantageously, the speed of the at least one rotator, at least one mini rotator and/or internal rotator may be adjusted according to the type of pipe coating removal required.

Ideally, the rotator drive means has a clutch mechanism.

Additionally, the pipe coating removal apparatus comprises at least one idler drum.

Ideally, the idler drum is locatable between the rotators to prevent bowing of the pipe.

Ideally, the pipe coating removal apparatus comprises a loading means.

Preferably, the pipe coating removal apparatus comprises a loading means for loading/unloading the pipe onto/off the pipe coating removal apparatus.

Preferably, the loading means is operable to load/unload the pipe onto/off the at least one rotator.

Preferably, the loading means is operable to load/unload the pipe onto/off the two or more rotators.

Advantageously, the loading means takes the weight of the pipe during loading thereby preventing damage to the pipe support means and, more specifically, to the at least one rotator.

Preferably, the pipe coating removal apparatus comprises at least one loading component.

Preferably, the loading means comprises at least one loading component.

Preferably, the at least one loading component is fixed, preferably movably fixed, to the pipe support means.

Preferably, the at least one loading component comprises a receiving portion suitable for receiving and supporting a pipe.

Preferably, the receiving portion has two raised end sections and a lowered middle section.

Preferably, the receiving portion has a receiving surface which is in contact with the pipe during loading/unloading.

Preferably, the receiving surface is shaped to accommodate the outer diameter of a section of a pipe.

Advantageously, shaping the receiving surface to accommodate a section of the outer diameter of a pipe prevents the pipe from rolling off the at least one loading component during loading and unloading.

Preferably, the receiving surface comprises an impact bed runner for absorbing shock from the pipe being loaded.

Preferably, the impact bed runner is composed of shock absorbent materials such as nylon, rubber or high polymer plastics etc.

Advantageously, the impact bed runner reduces vibration and damage to the pipe coating apparatus caused by loading a pipe.

Ideally, the at least one loading component can be raised and/or lowered.

Preferably, the pipe coating removal apparatus comprises an actuator for raising and/or lowering the at least one loading component.

Preferably, the receiving portion is operably connected to the actuator for the raising and/or lowering of the at least one loading component.

Advantageously, the actuator for raising and/or lowering the receiving portion enables the pipe to be carefully lifted onto or off the apparatus and/or at least one rotator.

Preferably, the actuator for raising and/or lowering the at least one loading component and/or receiving portion is a hydraulic ram and/or any other suitable means.

Preferably, the at least one rotator can only rotate when the at least one loading component is in a fully lowered position and is not being operated.

Advantageously, only enabling the at least one rotator to rotate when the at least one loading component is in a fully lowered position and is not being operated ensures that the at least one rotator will not rotate when a pipe is being loaded/unloaded onto/off the pipe coating removal apparatus and therefore prevents damage to the pipe.

Preferably, the at least one loading component can only be raised and/or lowered when all rotators are not operational.

Ideally, the at least one loading component can only be raised and/or lowered when the tool carriage is in a home position.

By home position, we mean any position where the tool carriage is not overlapping any part of the pipe.

Ideally, the pipe support means is configurable to move the pipe relative to the tool carriage.

Ideally, the pipe support means is configurable to move the pipe longitudinally relative to the tool carriage.

Ideally, the pipe support means is configurable to move the pipe through the tool carriage.

Ideally, the pipe support means is configurable to move the pipe past the tool carriage.

Preferably, the pipe coating removal apparatus comprises a restraining means to restrain a pipe on the pipe coating removal apparatus.

Preferably, the pipe coating removal apparatus comprises a restraining means to restrain a pipe on the pipe support means.

Preferably, the pipe coating removal apparatus comprises a restraining means.

Ideally, the pipe support means comprises a restraining means.

Preferably, the restraining means is configurable to engage with one or both ends of the pipe to maintain the pipe at a predetermined positioned on the pipe support means.

Advantageously, the restraining means keeps the pipe at a predetermined position during operation of the pipe coating removal apparatus.

Ideally, the restraining means is adjustable to support different lengths of pipe.

Preferably, the restraining means is fixed to the at least one contact element.

Preferably, the restraining means is fixed to the at least one rotator.

Advantageously, fixing the restraining means to the at least one contact element and/or rotator enables adjustment of the position of the restraining means for position of different lengths of pipe.

Ideally, the restraining means comprises one or more end restraints to prevent end float of the pipe.

Preferably, the restraining means comprises one or more internal restraints to prevent lift of the pipe away from the pipe support means during rotation of the pipe.

Ideally, the one or more internal restraints are configurable to hold the pipe down on the pipe support means.

Ideally, the one or more internal restraints are configurable to rotate the pipe internally.

Preferably, the one or more internal restraints are configurable to rotate with the pipe.

Ideally, the one or more internal restraints are configurable to be rotated by a pipe in which they are restraining.

Preferably, the one or more end restraints and the one or more internal restraints comprise abutment elements for contacting the pipe.

Ideally, the abutment elements of the one or more end restraints abut against the pipe at or about the end of the pipe.

Ideally, the abutment elements of the one or more internal restraints abut against the internal surface of the pipe.

Ideally, the abutment elements are composed of one or more rollers, most preferably, nylon and/or steel rollers.

Advantageously, the rollers do not inhibit rotation of the pipe. The use of nylon provides a soft interface and thereby prevents damage to the pipe. The use of steel increases the durability of the rollers.

Preferably, the pipe coating removal apparatus comprises a control system to enable data capture and automated operations.

Preferably, the pipe coating removal apparatus comprises a control system to enable data capture and/or automation of operations.

Preferably, the pipe coating removal apparatus comprises a control system to enable data capture and automated operations such as a programmable logic controller, a relay logic system and/or any other suitable control system.

Ideally, the pipe coating removal apparatus comprises one or more sensors connected to the control system.

Ideally, the one or more sensors connected to the control system are input sensors.

Preferably, the pipe coating removal apparatus comprises one or more sensors for ensuring a desired amount of pipe coating is removed.

Preferably, the one or more sensors for ensuring the desired amount of pipe coating is removed comprises a paint thickness gauge configurable to read the microns of materials left on a pipe supportable by the pipe support means.

Preferably, the one or more tools have associated sensors.

Preferably, the one or more tools have associated pressure sensors.

Preferably, the one or more tools have associated heat sensors.

Advantageously, the associated sensors reduce the requirement for manual intervention and provide extra protection against human error.

Ideally, the pipe coating removal apparatus comprises a visual feedback mechanism to observe operation of the tools.

Preferably, in one embodiment, the cutting tool(s), scraping tool(s) and/or abrasive tool(s) have an independent visual feedback mechanism.

Ideally, the visual feedback mechanism comprises one or more cameras.

Advantageously, having an independent visual feedback mechanism for the cutting tool(s), scraping tool(s) and/or abrasive tool(s) enables the operator to visualise each tool more clearly and detect any problems or damage more quickly and clearly.

Preferably, the pipe coating removal apparatus comprises a fire suppression means such as sprinklers or any other suitable means.

Ideally, the tool carriage comprises a fire suppression means.

Ideally, the fire suppression means is locatable on the cutting tool(s), scraping tool(s) and/or abrasive tool(s).

Preferably, the pipe coating removal apparatus comprises an air handling system for controlling circulation of dust and/or other pollutants resulting from the pipe coating removal process.

Preferably, the tool carriage comprises an air handling system for controlling the circulation of dust and other pollutants inside the carriage.

Advantageously, the air handling system reduces the risk of toxic chemicals being dispersed into the working environment or settling on the pipe coating removal apparatus.

Ideally, the air handling system comprises an extraction unit for extracting air from the tool carriage.

Ideally, the air handling system comprises at least one suction duct located within the tool carriage.

Ideally, the air handling system comprises at least one extraction conduit extending between the extraction unit and at least one suction duct.

Ideally, each pipe coating removal tool comprises at least one suction duct.

Ideally, in use, dust and airborne particles are collected via the at least one suction duct and are transported along the conduit to the extraction unit.

Ideally, the air handling system comprises a plurality of suction ducts in fluid communication with the extraction unit, most preferably via a single extraction conduit.

Preferably, each of the at least eight tools comprise at least one suction duct.

Preferably, the pipe coating removal tools have at least one suction duct at the front of the respective tool and at least one suction duct at the back of the respective tool.

Preferably, each of the at least eight tools comprise at least one suction duct at the front of the respective tool and at least one suction duct at the back of the respective tool.

Advantageously, having at least one suction duct at the cutting tool(s), scraping tool(s) and abrasive tool(s) enables the pipe coating removal apparatus to efficiently disperse of harmful waste product away from the tool carriage and working environment.

Ideally, the pipe coating removal apparatus comprises a waste collection system for collecting waste resulting from the pipe coating removal process.

Preferably, the pipe support means comprises a waste collection system.

Preferably, the waste collection system has one or more conveyors for delivering waste away from the tool carriage.

Ideally, the waste collection system comprises a conveyor for carrying the waste to a hopper.

Preferably, in one embodiment, the waste collection system also comprises a shredder for reducing the size of waste coating.

Preferably, the pipe coating removal apparatus comprises at least one cleaning tool for cleaning the pipe.

Ideally, the pipe coating removal apparatus comprises at least one water jet for cleaning the pipe.

Ideally, the pipe coating removal apparatus comprises at least one internal water jet for cleaning the internal surface of the pipe.

Ideally, the pipe coating removal apparatus comprises at least one internal brush for cleaning the internal surface of the pipe.

Preferably, the pipe coating removal apparatus comprises a cleaning carriage.

Preferably, the cleaning carriage comprises at least one water jet, internal water jet and/or internal brush for cleaning the pipe.

Ideally, the cleaning carriage is configurable to store cleaning medium.

Ideally, the cleaning carriage comprises a hopper to store cleaning medium.

Ideally, the cleaning carriage is supportable on the pipe support means.

Ideally, the cleaning carriage is moveable along the pipe support means.

Additionally, or alternatively, the cleaning carriage is supportable off of the pipe support means.

Additionally, or alternatively, the cleaning carriage is supportable off of the pipe support means on a plurality of wheels, external vehicle and/or any other suitable means.

Ideally, the cleaning carriage is electrically, hydraulically, or any other way suitably driven.

Ideally, the cleaning carriage is powered by diesel, electric and/or is hybrid driven.

Preferably, the at least one cleaning tool is supportable on a boom.

Ideally, the boom extends from the cleaning carriage.

Preferably, the pipe coating removal apparatus comprises an internal support means for supporting the boom inside the pipe.

Ideally, the internal support means comprises one or more support wheels.

Ideally, the internal support means is adjustable to suit the internal pipe diameter.

Preferably, the cleaning carriage comprises a control panel for controlling the at least one cleaning tool, boom and or internal support means.

Preferably, the pipe coating removal apparatus comprises walkways for safe access to elements and tools of the pipe coating removal apparatus.

Preferably, the pipe coating removal apparatus comprises a safety system to shut down the apparatus.

Ideally, the safety system comprises manual and/or automatic emergency stop triggers.

Ideally, the automatic stop systems comprise a plurality of gates located at positions along the walkways which cut off the electric circuit upon opening.

Advantageously, this enables quick stop of the apparatus to provide safety to personnel on the surrounding walkways.

Ideally, the manual emergency stop triggers consist of a plurality of emergency stop buttons.

Advantageously, the apparatus can be quickly and easily stopped in case of an emergency.

Ideally, in one embodiment the pipe coating removal apparatus comprises a pre-loading frame for storing pipes prior to the pipe being loaded onto the pipe support means.

Preferably, the pre-loading frame has a lateral loading arrangement capable of moving a length of pipe onto the loading components.

Advantageously, the lateral loading arrangement enables continuous loading of pipes in succession.

Preferably, the pipe coating removal apparatus comprises one or more sensors for monitoring dust levels.

Preferably, the pipe coating removal apparatus comprises one or more sensors for monitoring noise levels.

Preferably, the pipe coating removal apparatus comprises one or more sensors for monitoring heat levels.

Preferably, the pipe coating removal apparatus comprises one or more thermal imaging cameras for monitoring heat levels.

Preferably, the pipe coating removal apparatus comprises one or more sensors and/or cameras for monitoring wear on tools.

Preferably, the pipe coating removal apparatus comprises one or more sensors for monitoring excess vibration of the pipe coating removal apparatus, tool carriage, tool frame, tools and/or of a pipe supportable on the pipe support means.

Preferably, the pipe coating removal apparatus comprises one or more sensors for monitoring run time of each tool.

Preferably, the pipe coating removal apparatus comprises one or more sensors for monitoring run time for each pipe.

Preferably, the one or more time monitoring sensors are timers which are triggered upon activation of one or more other components of the pipe coating removal apparatus. For example, activation of the one or more rotators is configurable to trigger a timer and/or deactivation of the one or more rotators is configurable to stop the timer.

Preferably, the one or more sensors are configurable to connect to an online system to allow off site monitoring.

Preferably, the one or more sensors are configurable to connect to and online system so that the system can provide alerts on breakdowns.

Preferably, the pipe coating removal apparatus is mobile.

Preferably, the pipe coating removal apparatus is modular.

Preferably, the pipe coating removal apparatus is configurable to be dismantled and reassembled.

Preferably, the pipe coating removal apparatus is configurable to be dismantled and compacted for relocation of the pipe coating removal apparatus.

Advantageously, this enables quick and easy movement of the pipe coating removal apparatus from one location to another.

Preferably, the pipe coating removal apparatus is compactable.

Ideally, the pipe coating removal apparatus is configurable to fit inside a lorry trailer when it is dismantled.

Preferably, the pipe coating removal apparatus is configurable to fold into a lorry trailer when it is dismantled.

According to a second aspect of the invention, there is provided a pipe coating removal apparatus for removing all or some of the coating on a pipe, the pipe coating removal apparatus being capable of receiving a length of pipe and comprising a tool carriage, the tool carriage supporting at least a cutting tool, a scraping tool and one or more abrasive tools wherein each tool are configurable to be operated independently or simultaneously in any combination.

According to a third aspect of the invention, there is provided a pipe coating removal apparatus for removing all or some of the coating on a pipe, the pipe coating removal apparatus being capable of receiving a length of pipe and comprising a tool carriage, the tool carriage supporting at least a cutting tool, a scraping tool and one or more abrasive tools, the one or more abrasive tools including a brushing tool, a flap wheel tool and/or a sanding tool, for scraping, brushing and sanding off the coating on a pipe to remove all or some of the coating on the pipe.

According to a fourth aspect of the invention, there is provided a pipe coating removal apparatus for removing all or some of the coating on a pipe, the pipe coating removal apparatus being capable of receiving a length of pipe and comprising a tool carriage, the tool carriage being capable of supporting one or more pipe coating removal tools, the tool carriage being configured such that it can support a plurality of different combinations of tool types.

According to a fifth aspect of the invention, there is provided a pipe coating removal apparatus for removing all or some of the coating on a pipe, the pipe coating removal apparatus comprising a pipe support means for supporting a length of pipe, and a tool carriage, the tool carriage being capable of supporting two different types of pipe coating removal tools, the tool carriage and pipe support means being capable of moving relative to each other to remove all or some of the coating on a pipe that is supportable by the pipe support means.

According to a sixth aspect of the invention there is provided a method of removing pipe coating from a pipe, the method comprising operating a pipe coating removal apparatus for removing all or some coating on a pipe, the pipe coating removal apparatus comprising a pipe support means for supporting a length of pipe, and a tool carriage, the tool carriage capable of supporting two or more different pipe coating removal tool types and moving relative to the pipe support means.

Ideally, the method comprising the step of operating a loading means to load a pipe onto the pipe support means and/or onto the one or more contact elements of the pipe coating removal apparatus.

Ideally, the method comprising the step of operating the tool carriage to bring it into position over the pipe.

Ideally, the method comprising the step of bringing the relevant pipe coating removal tool(s) into engagement with the pipe.

Ideally, the method comprising the step of operating the two or more different types of pipe coating removal tools independently or simultaneously to remove all or some of the pipe coating.

Ideally, the method comprising the step of activating the air handling system to extract dust particles from the pipe coating removal apparatus and tool carriage.

Ideally, the method comprising the step of operating the waste collection system to catch and remove waste coating and debris away from the pipe coating removal apparatus and tool carriage.

Ideally, the method comprising the step of operating the tool carriage to move over the pipe, while the pipe coating removal tool(s) are in engagement with the pipe, until the required amount of pipe coating is removed.

Ideally, the method comprising the step of operating the cutting tool if and when required to create a longitudinal cut in the coating along a length of a pipe supportable on the pipe coating removal apparatus.

Ideally, the method comprising the step of operating the rotator(s) to rotate the pipe when required.

Ideally, the method comprising the step of operating the scraping tool if and when required to create a circumferential scrape to remove all or some of the coating on a pipe supportable by the pipe coating removal apparatus.

Ideally, the method comprising the step of operating the brushes if and when required to remove all or some of the coating on a pipe supportable by the pipe coating removal apparatus.

Ideally, the method comprising the step of operating the sanding tools if and when required to remove all or some of the coating on a pipe supportable on the pipe support means.

Ideally, the method comprising the step of bringing the pipe coating removal tool(s) and tool carriage out of engagement with and away from the pipe.

Ideally, the method comprising a final step of operating the loading means to trigger sensors disconnecting the drive means to the rotator(s) and to safely unload the pipe from the pipe coating removal apparatus.

The invention will now be described with reference to the accompanying drawings which shows by way of example only one embodiment of an apparatus in accordance with the invention.

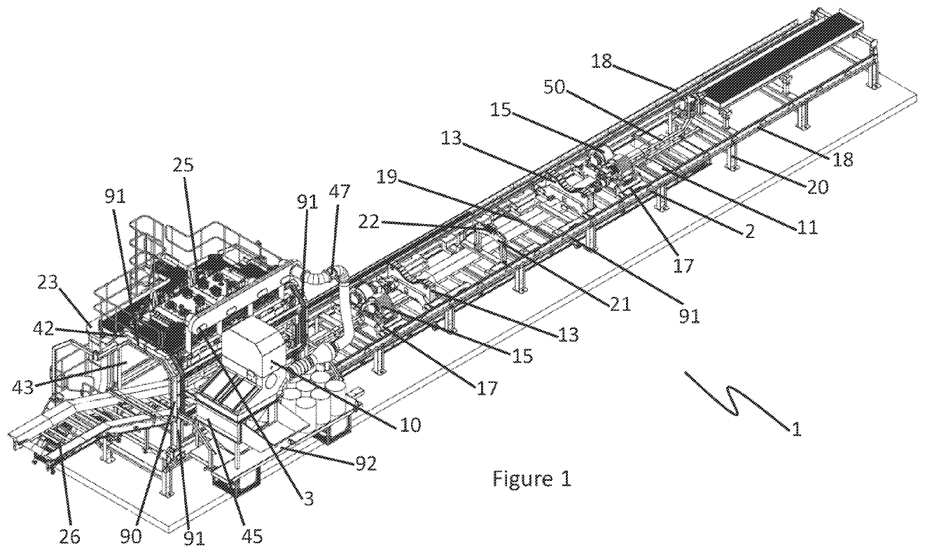

FIG. 1 is a perspective view of a pipe coating removal apparatus according to the invention.

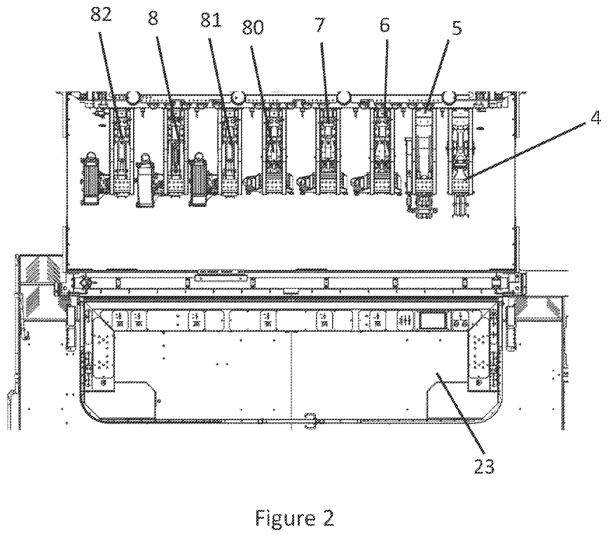

FIG. 2 is a plan view of a tool carriage according to the invention.

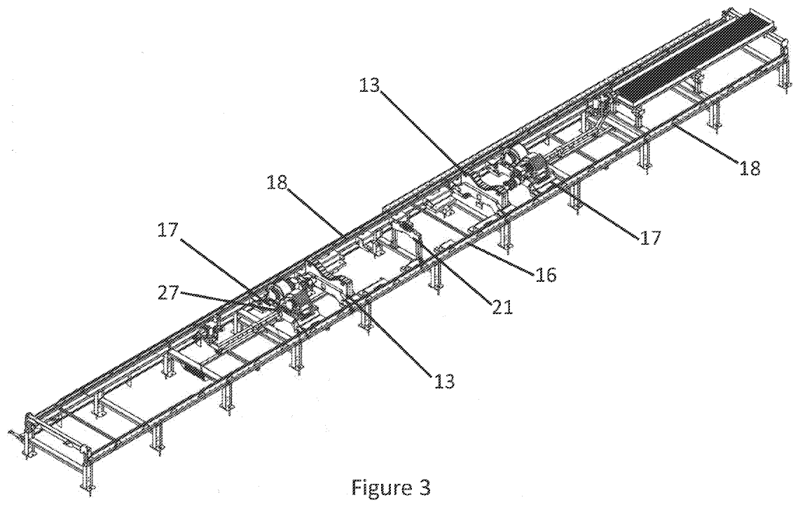

FIG. 3 is a perspective view of a pipe support means according to the invention.

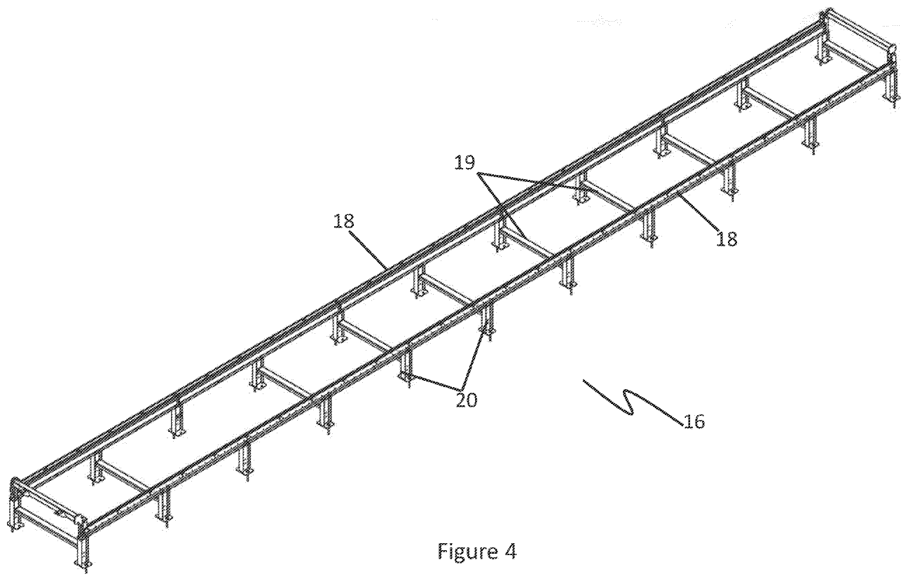

FIG. 4 if a perspective view of the framework of a pipe support means according to the invention.

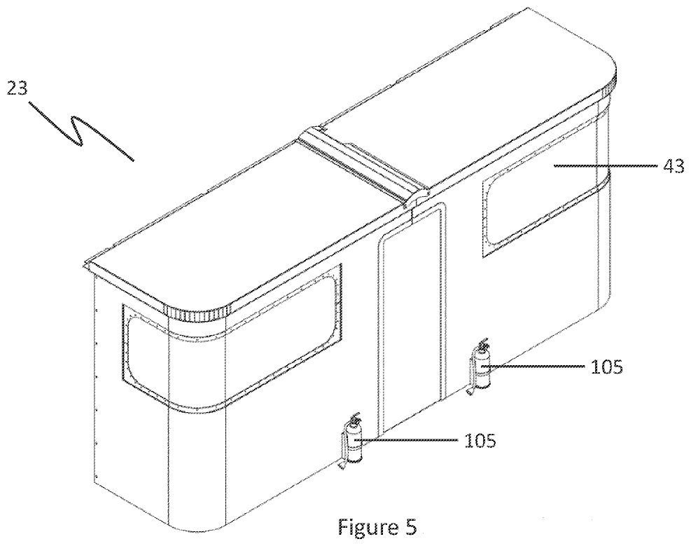

FIG. 5 is a perspective view of a tool carriage according to the invention.

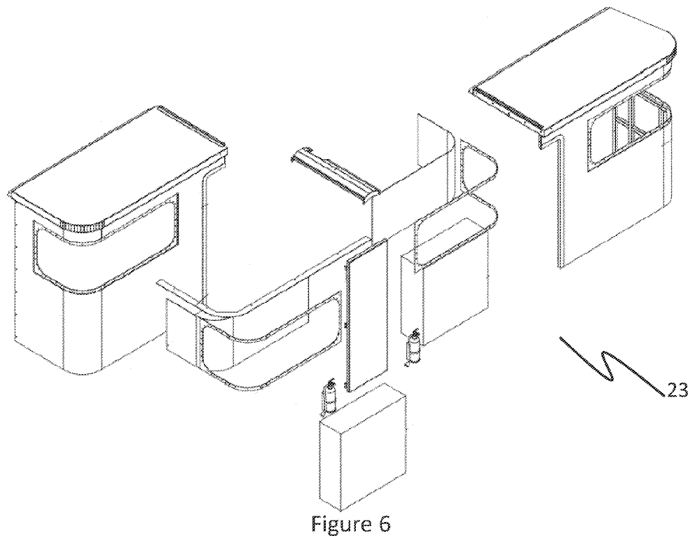

FIG. 6 is an exploded view of a tool carriage according to the invention.

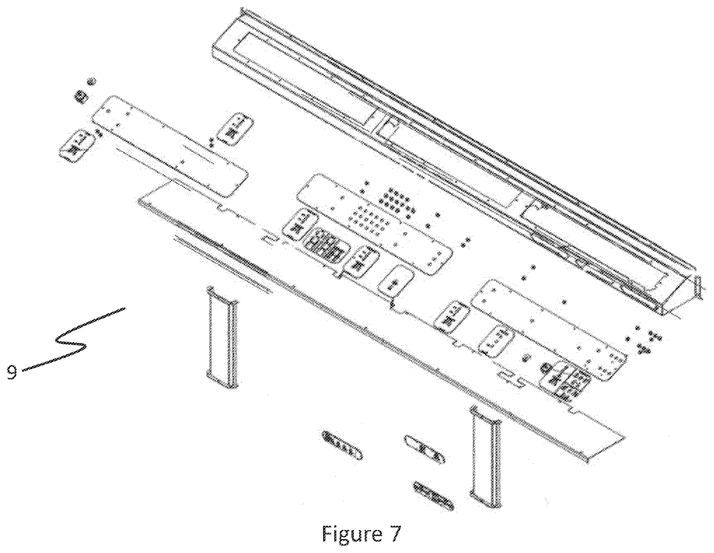

FIG. 7 is a control panel according to the invention.

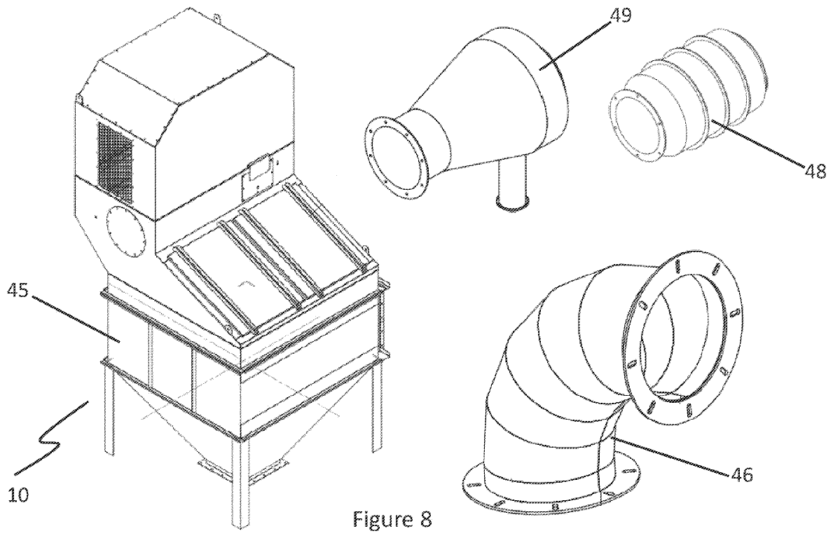

FIG. 8 is a perspective view of an air handling system according to the invention.

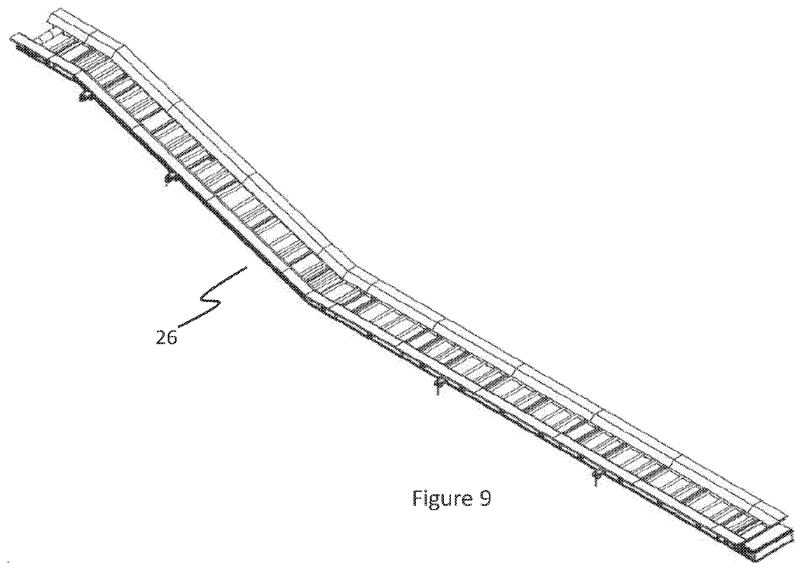

FIG. 9 is a perspective view of a conveyor according to the invention.

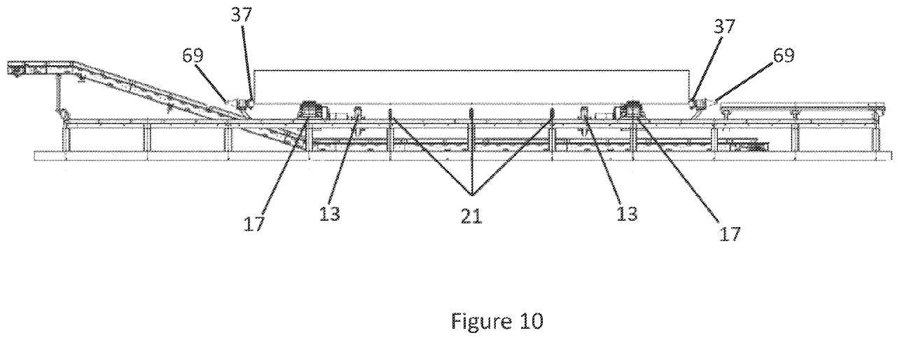

FIG. 10 is a side view of a pipe coating removal apparatus.

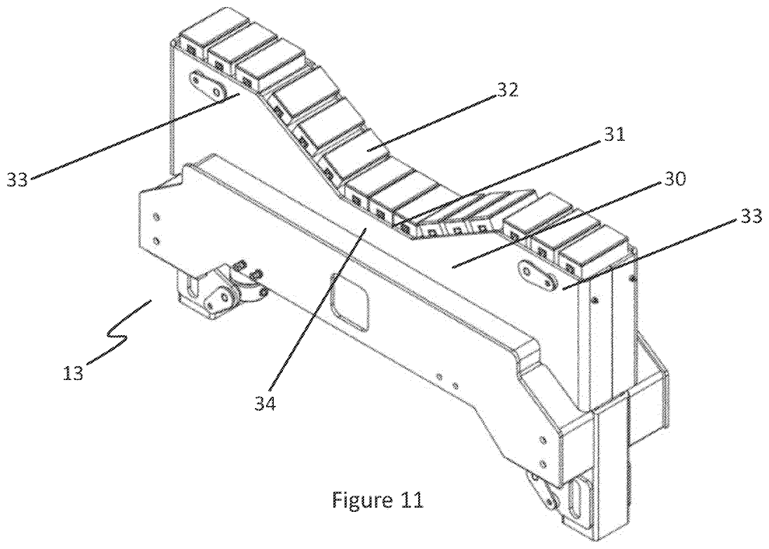

FIG. 11 is a perspective view of a loading component according to the invention.

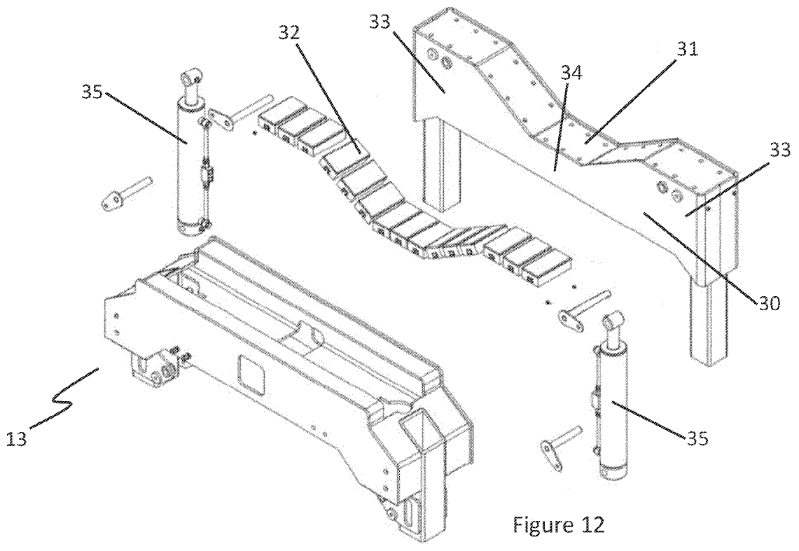

FIG. 12 is an exploded view of a loading component.

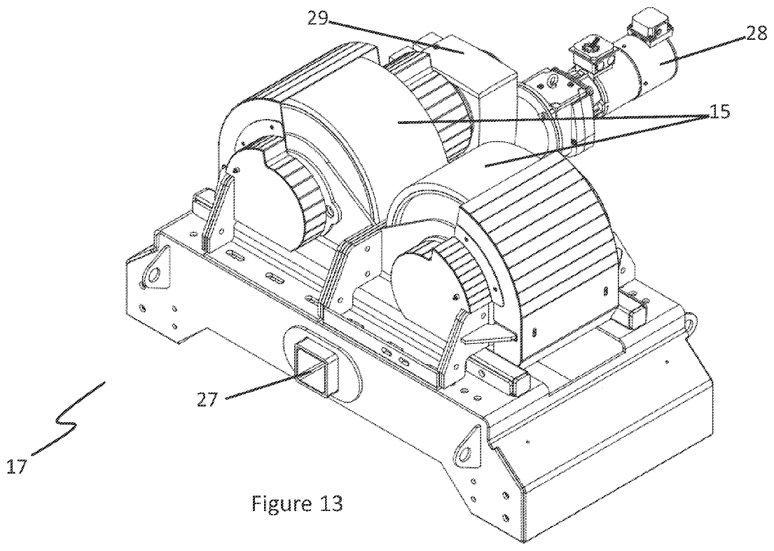

FIG. 13 is a perspective view of a contact element according to the invention.

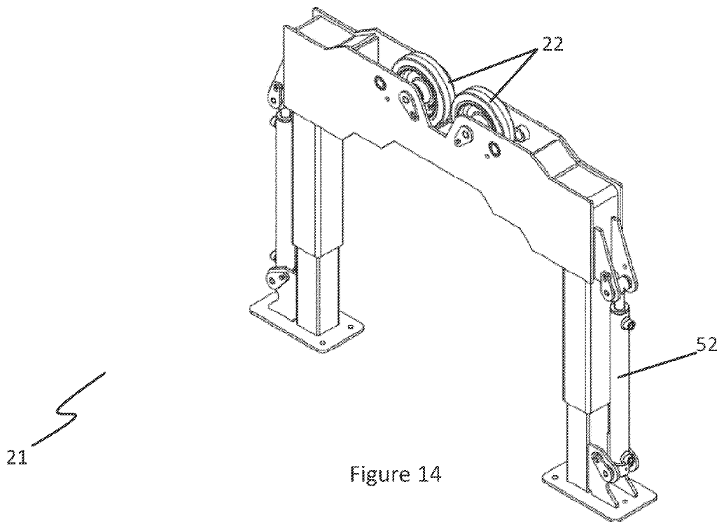

FIG. 14 is a perspective view of a mini contact element according to the invention.

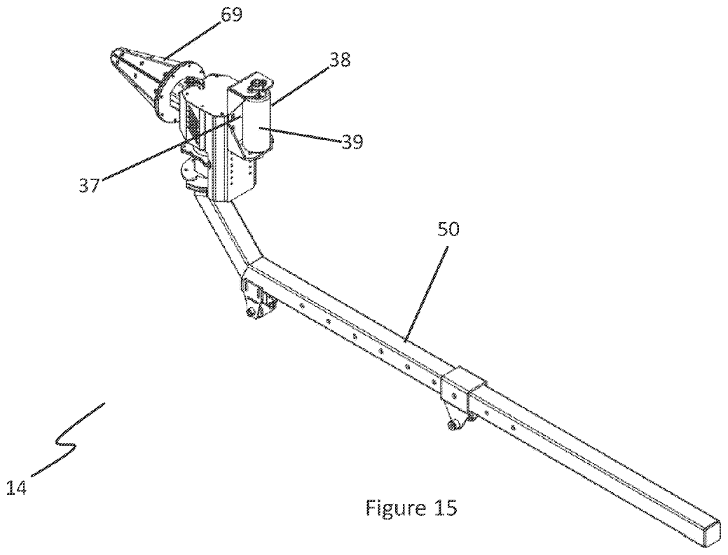

FIG. 15 is a perspective view of an end restraint according to the invention.

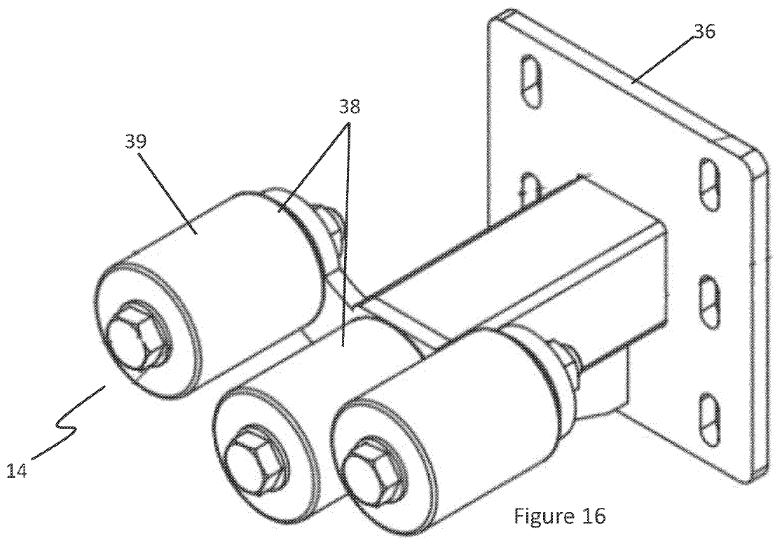

FIG. 16 is a perspective view of an internal restraint according to the invention.

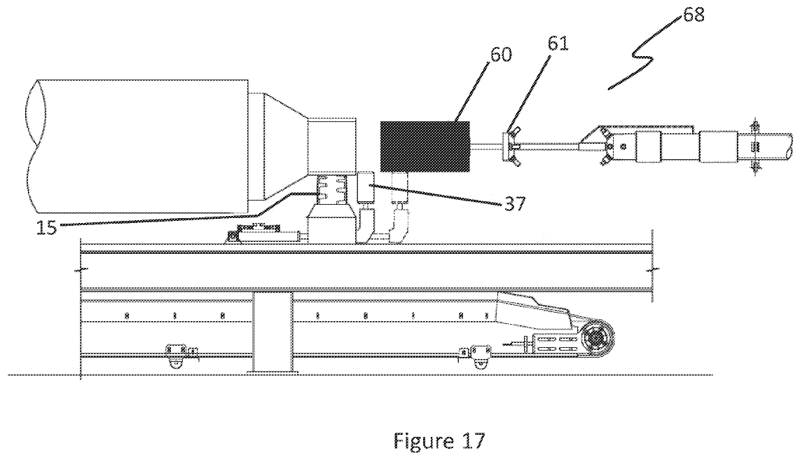

FIG. 17 is a perspective view of a cleaning arrangement according to the invention.

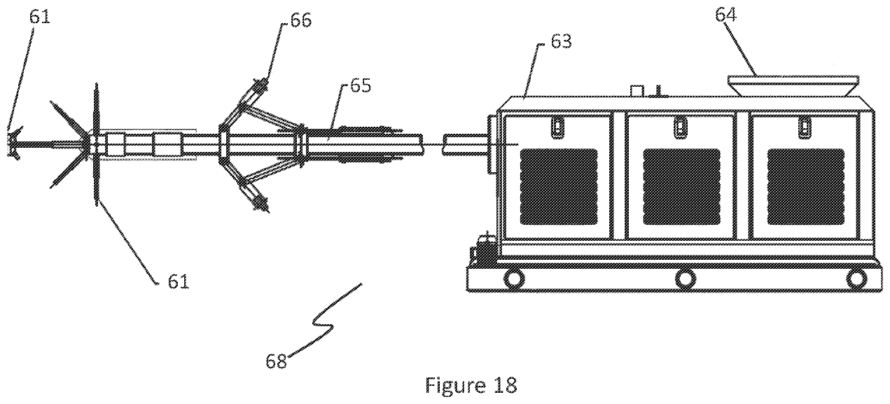

FIG. 18 is a second perspective view of a cleaning arrangement.

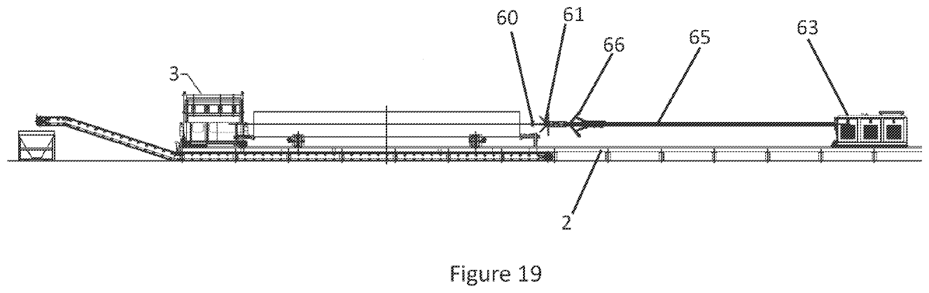

FIG. 19 is a side view of a second embodiment of a pipe coating removal apparatus.

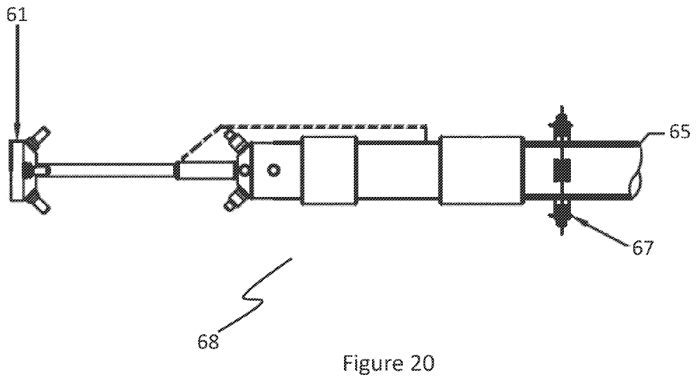

FIG. 20 is a third perspective view of a cleaning arrangement.

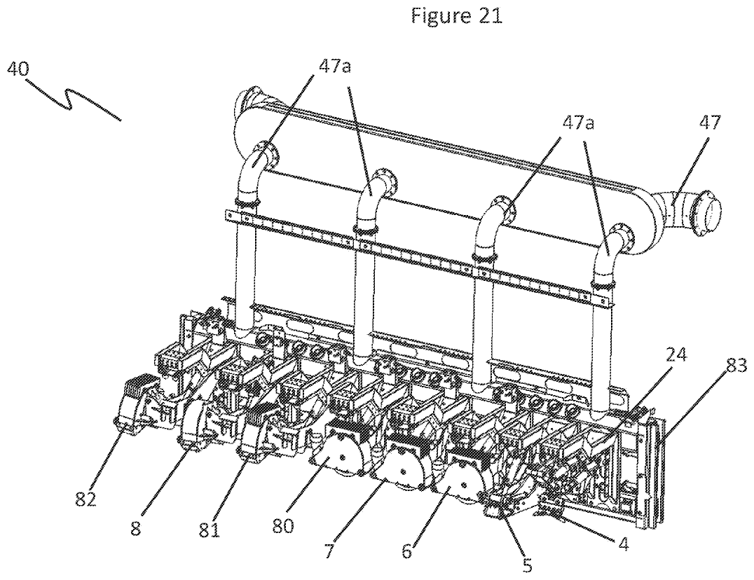

FIG. 21 is a perspective view of a tool frame according to the invention.

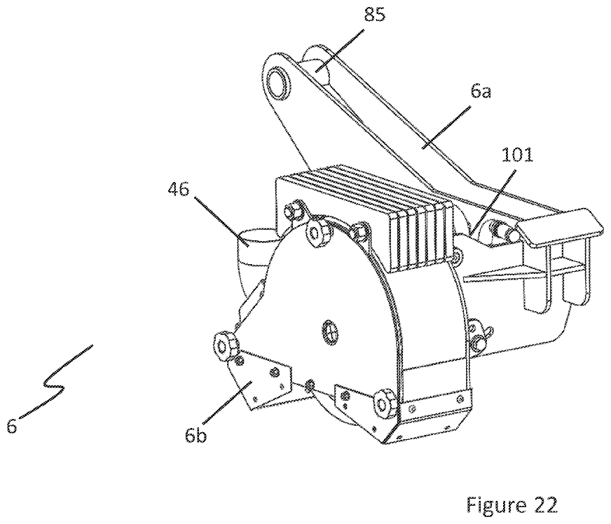

FIG. 22 is a perspective view of a transverse wire brush.

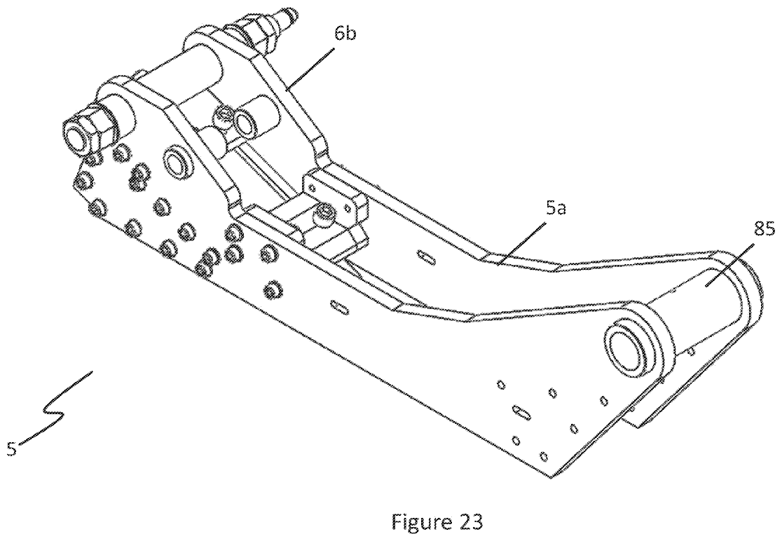

FIG. 23 is a perspective view of a scraping tool.

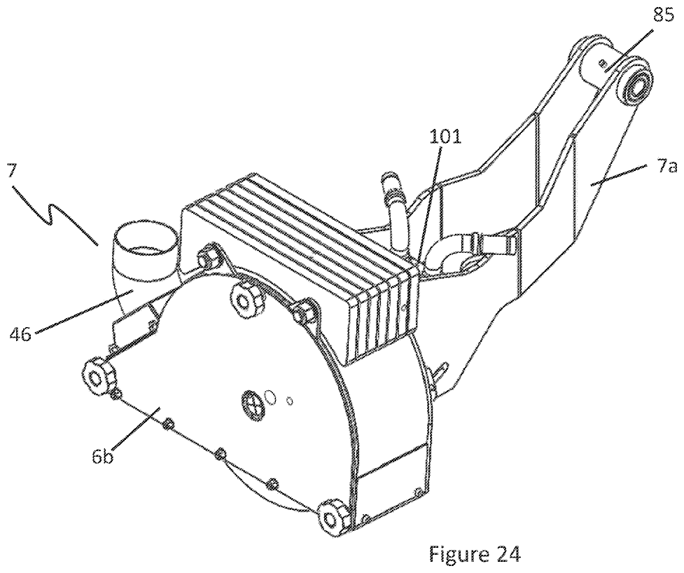

FIG. 24 is a perspective view of a longitudinal wire brush.

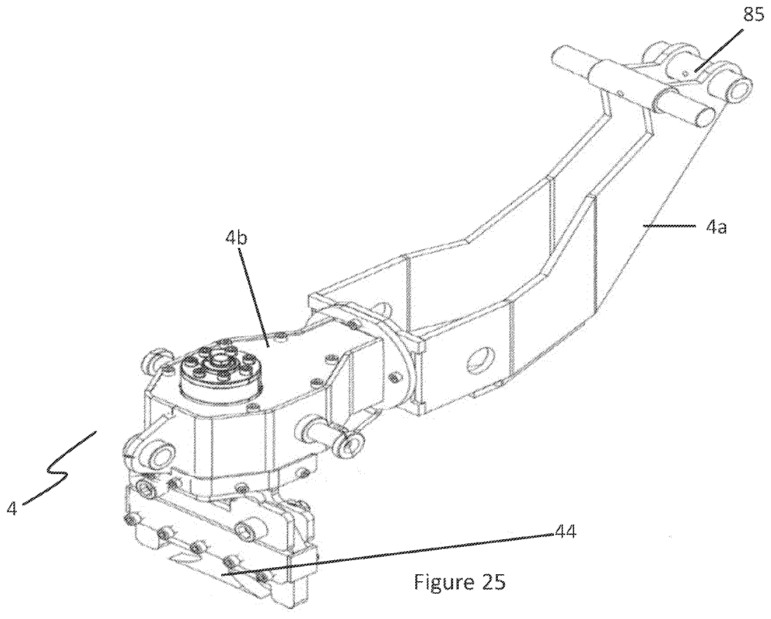

FIG. 25 is a perspective view of a cutting tool.

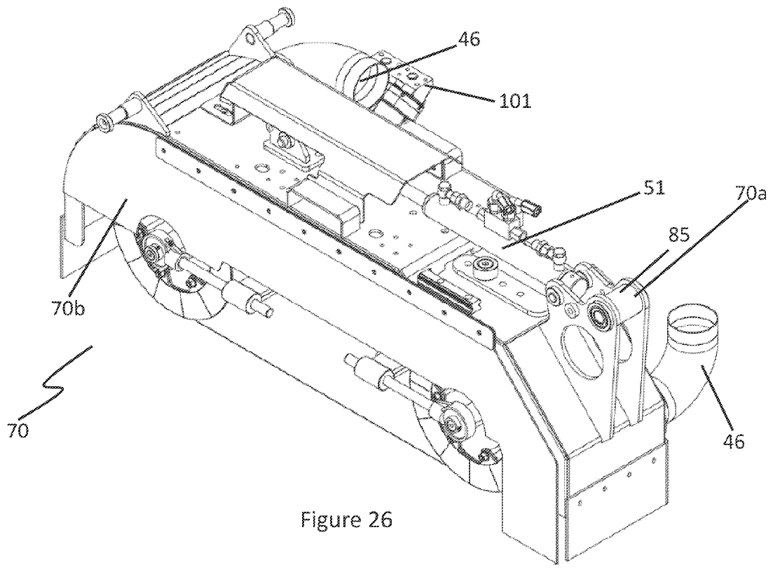

FIG. 26 is a perspective view of a belt sander.

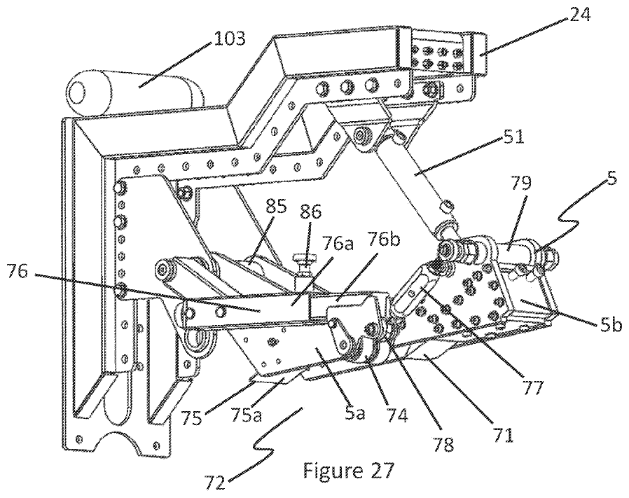

FIG. 27 is a perspective view of a scraping tool having a guide means.

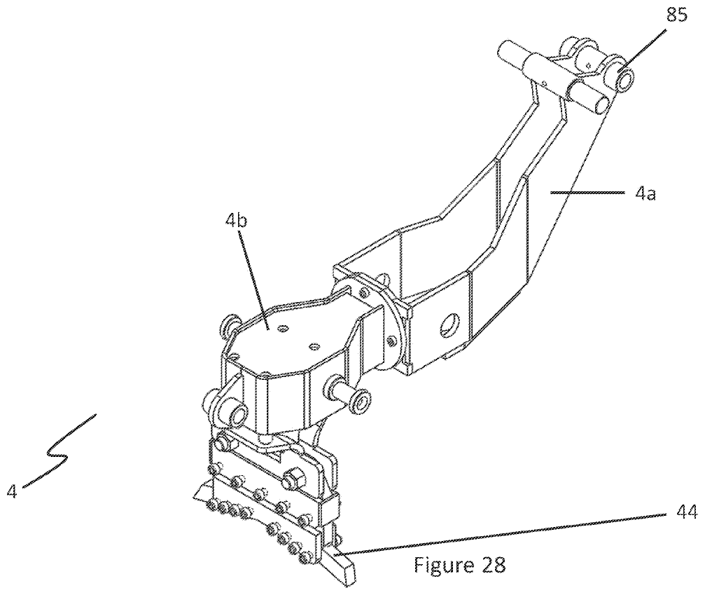

FIG. 28 is a perspective view of a second embodiment of a cutting tool.

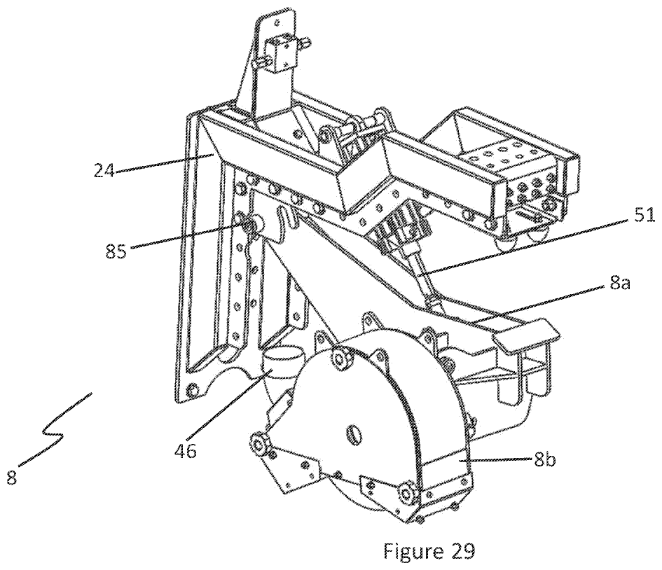

FIG. 29 is a perspective view of a flap wheel tool.

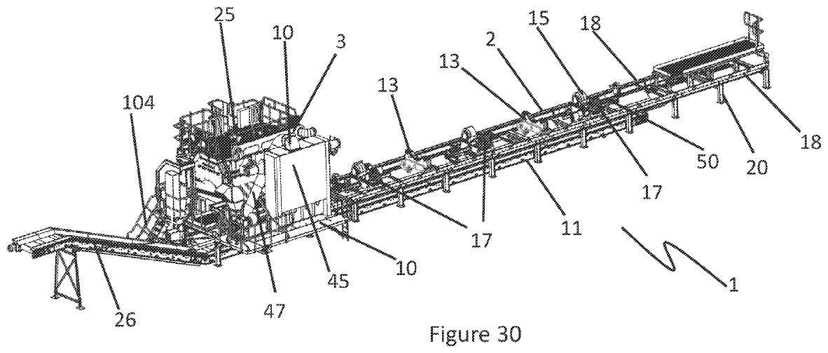

FIG. 30 is a perspective view of a second embodiment of the pipe coating apparatus.

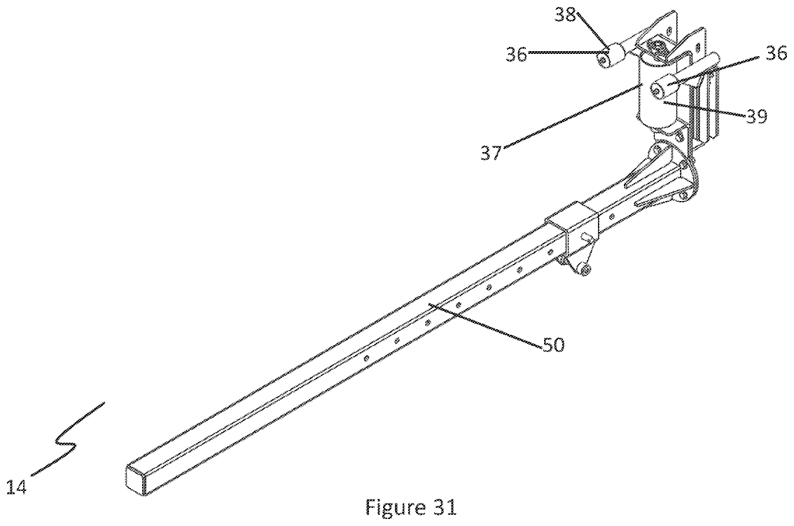

FIG. 31 is a perspective view of a second embodiment of an end restraint.

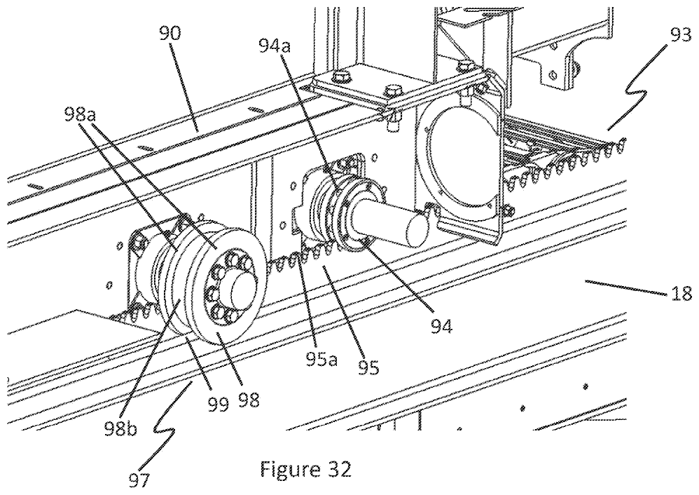

FIG. 32 is a perspective view of a tool carriage drive arrangement.

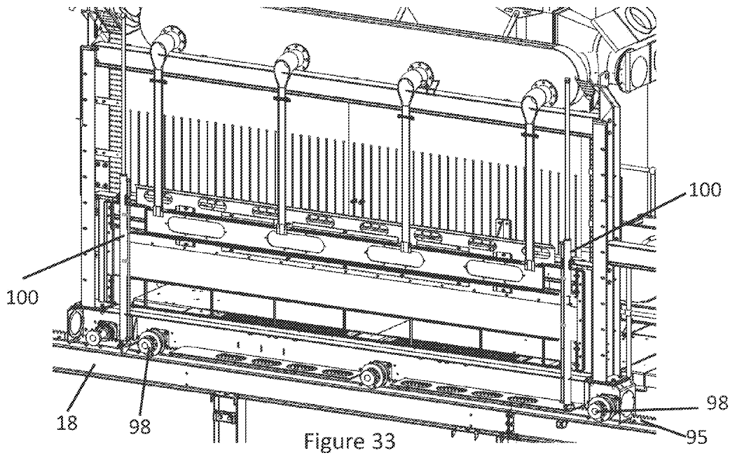

FIG. 33 is a section view of a tool carriage drive arrangement.

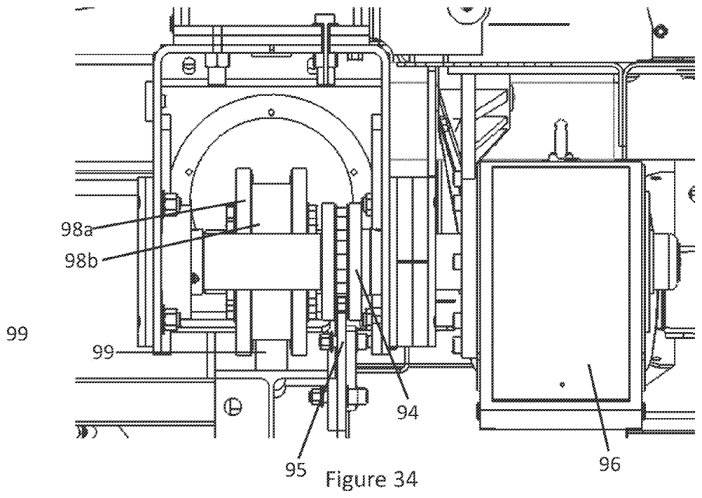

FIG. 34 is a second section view of tool carriage drive arrangement.

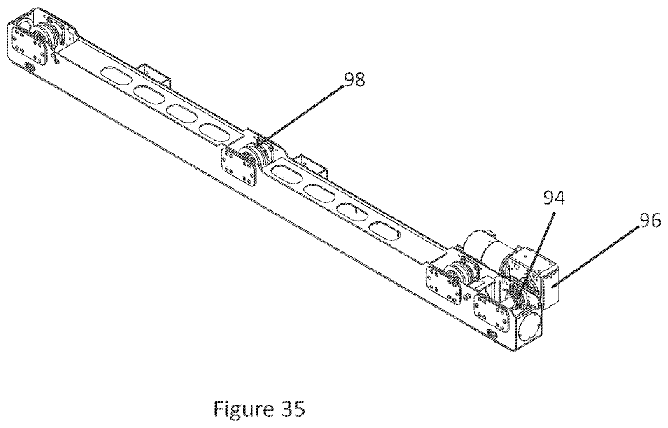

FIG. 35 is a second perspective view of a tool carriage drive assembly.

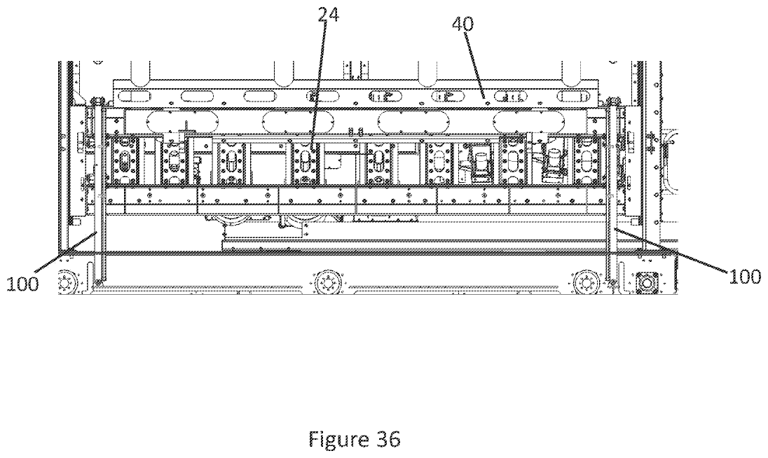

FIG. 36 is a section view of a tool carriage.

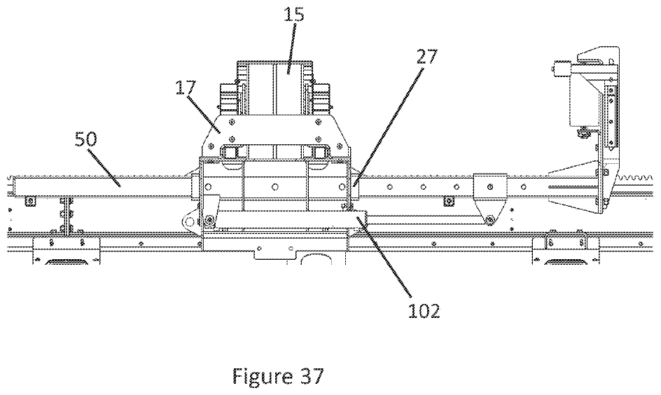

FIG. 37 is a section view a contact element.

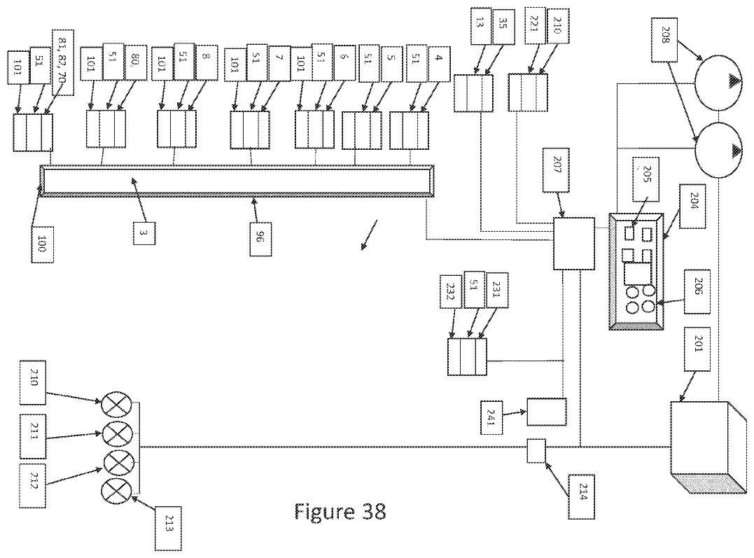

FIG. 38 is a schematic illustration of a control system for the pipe coating removal apparatus.

Referring to the drawings, there is shown a pipe coating removal apparatus indicated generally by reference numeral 1. The pipe coating removal apparatus 1 has a pipe support arrangement 2 for supporting a length of pipe, and a tool carriage 3. The tool carriage 3 is capable of supporting a plurality of types of pipe coating removal tools and is also capable of moving relative to the pipe support arrangement 2 to remove all or some of the coating on a pipe that is supported by the pipe support arrangement 2. The pipe support arrangement 2 is capable of moving a pipe relative to the tool carriage to remove all or some of the coating on the pipe. The pipe coating removal apparatus 1 is capable of moving the tool carriage 3 and a pipe being supported on the pipe support arrangement 2 relative to one another. The pipe coating removal apparatus 1 and/or tool carriage 3 supports a plurality of tools. The tool carriage 3 is configured to support at least two tools. In this embodiment, the tool carriage 3 can support eight tools. The pipe coating removal apparatus 1 is capable of rotating a pipe being supported on the pipe support arrangement 2. The tool carriage 3 as illustrated in FIG. 21 supports three different types of tools, more specifically the tool carriage 3 supports a cutting tool 4, a scraping tool 5 and abrasion tools 6, 7, 8, 80, 81 and 82. The tool carriage 3 as illustrated in FIG. 21 supports five different types of tools, more specifically the tool carriage 3 supports a cutting tool 4, a scraping tool 5, two transverse wire brush tools 81, 82, here longitudinal wire brush tools 6, 7, 80 and a flap wheel tool 8. By a transverse wire brush, we mean a wire brush having a tool head angled such that the plane of rotation of the wire brush is transverse to the longitudinal axis of a pipe being supported on the pipe support arrangement 2. By longitudinal wire brush, we mean a wire brush having a tool head angled such that the plane of rotation of the wire brush is parallel with the longitudinal axis of a pipe being supported on the pipe support arrangement 2. The tool carriage 3 may also have one or more spare tool holders 24 where another tool can be fitted. The location and/or type of tools is interchangeable on the tool carriage 3.

The pipe coating removal apparatus 1 has a drive arrangement for driving one or more component parts of the pipe coating removal apparatus 1. The drive arrangement is electrically, hydraulically and/or otherwise suitably powered. The pipe coating removal apparatus 1 has at least one electric motor 96 and at least one hydraulic motor 101. The pipe coating removal apparatus 1 has a hydraulic fluid storage arrangement. In this embodiment, the hydraulic fluid storage arrangement is a tank 25. In this embodiment, the pipe coating removal apparatus has one tool carriage 3. However, the pipe coating removal apparatus may have multiple tool carriages. The tool carriage 3 is weighted by the hydraulic tank 25 to reduce vibration of the pipe coating removal apparatus 1.

The tool carriage 3 supports a tool frame 40 (illustrated in FIG. 21) and a plurality of tool holders 24. In this embodiment, the tool holders 24 are secured to the tool frame 40 via mechanical fasteners such as bolts and/or screws. In this embodiment, the two or more pipe coating removal tools are releasably attached to the plurality of tool holders via one or more mechanical fasteners such as screws, bolts, pins and/or any other suitable means. Only one tool is attached to each tool holder at any one time. In this embodiment, the tool carriage 3 is constructed from steel. Constructing the tool carriage from steel provides a strong support for the tool frame 40 and tool holders 24. However, the tool carriage 3 may be constructed of any other suitable material such as metal alloy.

The pipe support arrangement 2 has a framework 16 for supporting a pipe and/or guiding movement of the tool carriage 3 along a pipe, when in use. The framework 16 is formed of two spaced apart, parallel beams, more specifically, the beams are I-section beams 18 formed from steel. Alternatively, the beams 18 may be formed of any other suitable material. The beams 18 are secured together by reinforcements 19. The reinforcements 19 include a plurality of spaced cross members extending between the beams 18. The framework 16 is supported off the ground by a plurality of supports 20. This enables sufficient room for other elements of the pipe coating removal apparatus 1 to operate.

The tool carriage 3 is supported on the pipe support arrangement 2. The pipe coating removal apparatus 1 has a tool carriage structural support frame 90, as indicated in FIG. 1. The tool carriage structural support frame 90 extends upright from one of the spaced apart parallel beams 18 of the pipe support arrangement 2. The tool carriage structural support frame 60 extends across the pipe support arrangement 2 towards the other spaced apart parallel beam 18. The tool carriage structural support frame 90 is an inverted U shape. The tool carriage structural support frame 90 has a main frame which is an inverted U shape. The tool carriage structural support frame 90 extends upright from both of the spaced apart parallel beams 18 and across the structural support arrangement 2 to form an enclosure over at least part of the pipe support arrangement 2. The tool carriage structural support frame 90 extends upright from both of the spaced apart parallel beams 18 and across the structural support arrangement 2 to form an enclosure over at least part of a pipe supportable on the pipe support arrangement 2. The tool carriage structural support frame 90 has a plurality of stanchions, bars, beams and/or posts 91. The plurality of stanchions, bars, beams and/or posts 91 extend upright from one or both of the spaced apart parallel beams 18 and across the pipe support arrangement to create a hood and/or roof structure 42. The tool carriage structural support frame 90 is configured to support the tool carriage 3, the hydraulic fluid storage tank 25 and/or one or more other component parts of the pipe coating removal apparatus 1. The tool carriage structural support frame 90 has one or more platforms 92 extending laterally from the inverted U shaped main frame, the platforms 92 are configured to support one or more other components of the pipe coating removal apparatus 1.

The tool carriage is moveable along the pipe support arrangement 2. The tool carriage 3 is moveable along the spaced apart parallel beams 18 of the pipe support arrangement 2. The pipe coating removal apparatus 1 has a tool carriage drive arrangement 93 configurable to cause movement of the tool carriage 3 along the pipe support arrangement 2. The tool carriage drive arrangement 93 has a plurality of gear wheels 94 locatable on the tool carriage structural support frame 90 and/or one the stanchions, bars, beams and/or posts 91 of the tool carriage support frame 90. The tool carriage drive arrangement 93 has two or more gear plates 95. Each of the spaced apart parallel beams 18 of the structural support arrangement 2 has a gear plate 95 which run along the length of the spaced apart beam 18. At least one of the gear wheels 94 engages with a gear plate 95 of one of the spaced apart parallel beams 18 and at least one of the gear wheels 94 engages with the gear plate 95 of the other spaced apart parallel beams 18. The two or more gear wheels 94 have a plurality of radially projecting teeth 94a. The two or more gear plates 95 have a plurality of upwardly projecting crank teeth 95a. The plurality of teeth 94a of the two or more gear wheels 94 are configurable to slot between the plurality of teeth 95a of the two or more gear plates 95. In this embodiment, the tool carriage drive arrangement 93 has one or more electric motors 96 (illustrated in FIG. 34) to drive movement of the tool carriage 3 along the pipe support arrangement 2. The tool carriage drive arrangement 93 has a tool carriage guide arrangement 97 configured to guide linear movement of the tool carriage 3 over the pipe support arrangement 2. The tool carriage guide arrangement 97 is configurable to prevent slippage of the tool carriage 3 off the pipe support arrangement 2. The tool carriage guide arrangement 97 is configurable to maintain engagement of the tool carriage 3 with the pipe support arrangement 2. The tool carriage guide arrangement 97 has two or more carriage wheels 98 locatable on the tool carriage support frame 90 and two or more carriage rails 99. Each of the spaced apart parallel beams 18 of the structural support means comprises a carriage rail 99 which runs along the length of the parallel beam 18. The carriage rail 99 on each of the spaced apart parallel beams 18 runs along the length of the spaced apart parallel beam 18 parallel to the gear plate 95 on that spaced apparat parallel beam 18. At least one of the carriage wheels 98 engages with carriage rail 99 of one of the spaced apart parallel beams 18 and at least one of the carriage wheels 98 engages with the carriage rail 98 of the other spaced apart parallel beams 18. The two or more gear wheels 98 have a two circumferentially extending flanges 98a and a groove 98b which extends between the two circumferentially extending flanges 98a. The two or more carriage rails 99 extend outwardly from the spaced apart parallel beams 18. The two or more carriage rails 99 extend upwardly from the spaced apart parallel beams 18. Each of the carriage rails 99 extend into the groove 98b of the at least one engaging carriage wheel 98, between the circumferentially extending flanges 98a, to guide linear movement of the tool carriage 3.

The tool carriage is moveable over a pipe that is supported on the pipe support arrangement 2. The tool carriage 3 is hydraulically, electrically or any other way suitably powered. In this embodiment, the tool carriage 3 is driven by an electric motor 96 and a gear box on a steel wheel 94 and/or 98 with a gear plate system 94 and 95 and/or 98 and 99. The tool carriage 3 and/or tool carriage structural support frame 90 has a hood and/or roof structure 42 to protect the tools 4, 5, 6, 7 8, 80, 81 82 and/or 70 from external damage such as weather conditions. When a pipe is supported on the pipe support arrangement 2, the hood and/or roof structure 42 extends over the pipe.

The tool frame 40 is mounted on the tool carriage 3. The tool frame 40 is mounted on the tool carriage 3 and/or tool carriage structural support frame via one or more mechanical fasteners such as screws, bolts, pins and/or any other suitable means. The position of the tool frame 40 can be adjusted relative to the pipe support arrangement 2. The position of the tool frame 40 can be raised and lowered relative to the pipe support arrangement 2. The position of the tool frame 40 is slidably adjustable. The tool frame 40 is mounted on the tool carriage 3 and/or tool carriage structural support frame via two linear rails 83 (illustrated in FIG. 21). In this embodiment, the tool frame 40 can be raised and lowered relative to the pipe support arrangement 2 via hydraulic cylinders 100 (illustrated in FIGS. 33 and 36). However, the tool frame 40 may be raised and lowered by any other suitable means. The position of the tool frame can be adjusted from the cabin 23.

Each of the pipe coating removal tools have a tool arm 4a, 5a, 6a, 7a, 8a, 70a, 80a, 81a, 82a. The tool arm is releasably attached to the tool carriage 3 and/or tool holders 24. In the embodiment shown in the figures, the tool arm 4a, 5a, 6a, 7a, 8a, 70a, 80a, 81a, 82a of each of the two or more pipe coating removal tools is releasably attached to the tool holder 24 via a pin 85. The tool arm 4a, 5a, 6a, 7a, 8a, 70a, 80a, 81a, 82a is pivotable around the longitudinal axis of the pin 85. The tool arm 4a, 5a, 6a, 7a, 8a, 70a, 80a, 81a, 82a is configured to be raised and/or lowered via pivoting around the longitudinal axis of the pin 85. The tool arm of each of the two or more pipe coating removal tools extends from the portion of the tool carriage 3 and/or tool frame 40 and/or tool holder 24 to which it is attached. Each of the two or more pipe coating removal tools have a tool head 4b, 5b, 6b, 7b, 8b, 70b, 80b, 81b, 82b. The tool head extends from an end of the tool arm opposite to the end of the tool arm that is attached to the tool carriage 3 and/or tool frame 40 and/or tool holder 24. Preferably, the tool head is configured to be raised and/or lowered. The tool head 4b, 5b, 6b, 7b, 8b, 70b, 80b, 81b, 82b is configured to be raised and/or lowered via a hydraulic and/or pneumatic cylinder 51. In the embodiment illustrated, the hydraulic and/or pneumatic cylinder 51 is attached to the tool holder 24 at one end and to the tool head 4b, 5b, 6b, 7b, 8b, 70b, 80b, 81b, 82b at the other end. In use, at least a portion of the tool head 4b, 5b, 6b, 7b, 8b, 70b, 80b, 81b, 82b engages with the coating on a pipe being supported by the pipe support arrangement 2 to remove that coating.

In this embodiment, the pipe coating removal tools 6, 7, 8, 80, 81, 82 and/or 70 are driven via hydraulic motors 101 (illustrated in FIGS. 22, 24 and 26). However, the pipe coating removal tools may be driven by any other suitable means and/or motor. The pipe coating removal tools 4, 5, 6, 7 8, 80, 81, 82 and/or 70 can be operated independently and/or simultaneously from one another. The pipe coating removal tools 4, 5, 6, 7 8, 80, 81, 82 and/or 70 have independent actuators and can therefore be actuated at the same time or independently when required. Each of the pipe coating removal tools 4, 5, 6, 7 8, 80, 81, 82 have a hydraulic and/or pneumatic cylinders 51 to enable the pipe coating removal tools to be raised and/or lowered independently and/or simultaneously. The hydraulic and/or pneumatic cylinders 51 enable independent and/or simultaneously movement of each of the tool heads 4b, 5b, 6b, 7b, 8b, 70b, 80b, 81b, 82b towards and/or away from a pipe being supported on the pipe support arrangement 2.

In this embodiment, the cutting tool 4 is a longitudinal cutting tool 4 to create a longitudinal cut along the coating on a pipe being supported by the pipe support arrangement 2. The longitudinal cutting tool 4 has a blade 44. In this embodiment, the blade 44 is double acting. The blade 44 is located on the tool head 4b of the longitudinal tool head 4 so as to come into contact with the outer surface of the pipe.

In this embodiment, the scraping tool 5 is a circumferential scraping tool 5 for performing circumferential removal of coating on a pipe being supported on the pipe support arrangement 2, when in use. The circumferential scraping tool 5 has a scraping blade 71 located on the tool head 5b of the longitudinal scraping tool 5.

In this embodiment, the abrasion tools are wire brushes 6, 7, 80, 81, 82 and a flap wheel tool 8. Additionally, or alternatively, the pipe coating removal apparatus 1 may also have belt sanders indicated by reference numeral 70. In the embodiment illustrated in FIGS. 2 and 21, the tool head 6b, 7b and 80b of the wire brushes 6, 7 and 80 are angled transversely to the tool arms 6a, 7a and 80a. Therefore, the tool head 6b, 7b and 80b of the wire brushes 6, 7 and 80 are angled such that the plane of rotation of the wire brushes are parallel to the longitudinal axis of a pipe being supported on the pipe support arrangement 2. The tool head 81b and 82b of wire brushes 81 and 82 are angled such that they are parallel with the tool arms 81a and 82a. Therefore, the tool head 81b and 82b of the wire brushes 81 and 82 are angled such that the plane of rotation of the wire brushes 81 and 82 is transversal to the longitudinal axis of a pipe being supported on the pipe support arrangement 2. The tool heads 6b, 7b and 80b of the wire brushes 6, 7 and 80 are angled such that they are perpendicular to the tool heads 81b and 82b of the wire brushes 81 and 82. The wire brushes 6, 7, 80 81, 82 may be single head wire brushes and/or double head wire brushes.

The cutting tool(s) 4, scraping tool(s) 5 and/or abrasive tool(s) 6, 7, 8, 80, 81, 82 and/or 70 have at least one hydraulic and/or pneumatic cylinder 51. The hydraulic and/or pneumatic cylinders 51 are configured to raise and/or lower the tools 4, 5, 6, 7, 8, 80, 81, 82 and/or 70. The flap wheel tool 8 has a pneumatic cylinder 51. The belt sanders 70, as illustrated in FIG. 26 have hydraulic cylinders 51. Referring to FIGS. 2 and 21, the two or more pipe coating removal tools 4, 5, 6, 7, 8, 80, 81, 82 are adjacent to one another along the length of the tool frame 40.

The pipe coating removal apparatus 1 has a guide arrangement 72 (see FIG. 27) to guide engagement of at least one of the two or more pipe coating removal tools 4, 5, 6, 7, 8, 80, 81, 82 and/or 70 with a surface of a pipe being supported on the pipe support arrangement 2. The pipe coating removal apparatus 1 has a guide arrangement 72 to guide engagement of at least one of the two or more pipe coating removal tools 4, 5, 6, 7, 8, 81, 82 and/or 70 with a pipe coating on a surface of a pipe being supported on the pipe support arrangement 2, as the tool removes the pipe coating. The guide arrangement 72 is releasably attached to the two or more pipe coating removal tools 4, 5, 6, 7, 8, 81, 82 and/or 70. The guide arrangement 72 is releasably attached to the tool arm of the two or more pipe coating removal tools 4, 5, 6, 7, 8, 81, 82 and/or 70. Referring to FIG. 27, the guide arrangement 72 is releasably attached to a side portion of the tool arm 5a of the circumferential scraping tool 5. However, the guide arrangement may be releasably attached to any other portion of the tool 5 such as the underside of tool arm 5a.

The guide arrangement 72 has a guide roller 74. The guide arrangement 72 is configured to engage with the external surface of a pipe being supported on the pipe support arrangement 2. The guide roller 74 is configured to engage with the external surface of a pipe being supported on the pipe support arrangement 2. The guide arrangement 72 is configured to engage with the external surface of a pipe being supported on the pipe support arrangement 72, as the pipe rotates. The guide roller 74 is configured to engage with the external surface of a pipe being supported on the pipe support arrangement, as the pipe rotates. The guide roller 74 is rotatable. The guide roller 74 is configured to engage with the external surface of a pipe and rotate in response to rotation of the pipe. The guide roller 74 is rotatable via rotation of a pipe being supported on the pipe support arrangement 2. This prevents friction between the guide roller 74 and the pipe. The guide roller 74 is configured to maintain engagement with the external surface of a pipe being supported on the pipe support arrangement 2 as the pipe rotates. The guide roller 74 is configured to follow the contour of a pipe being supported on the pipe support arrangement 2. The guide roller 74 is configured to ride over any welds and/or dents on the external surface of a pipe being supported on the pipe support arrangement 2 while maintaining engagement with the external surface of the pipe. The guide arrangement 72 is configured to raise and/or lower depending on the contour of a pipe being supported on the pipe support arrangement. The guide arrangement 72 is configured to control the distance of the tool head 5b of the scraping tool 5 relative to the external surface of a pipe being supported on the pipe support arrangement. The guide arrangement 72 is configured to raise and/or lower the tool head 5b of the scraping tool 5 depending on the contour of the pipe being supported on the pipe support arrangement 2. The guide arrangement 72 is configured to raise the height of the tool head 5b in response to deformations such as welds and/or protrusions on the external surface of a pipe being supported on the pipe support arrangement 2. This prevents the tool head 5b digging into the external surface of the pipe and potentially causing damage to the pipe. The guide arrangement 72 is configured to lower the height of the tool head 5b in response to deformations such as dents on the external surface of a pipe being supported on the pipe support arrangement 2. This prevents the tool head 5b from coming out of engagement with the coating on the external surface of the pipe. Thereby, this ensures uniform removal of the coating from the external surface of the pipe. The guide arrangement maintains optimum distance of the tool head 5b relative to the external surface of a pipe being supported on the pipe support arrangement 2 to enable as much coating as possible to be removed from the external surface of the pipe, without damaging the pipe. The guide roller 74 engages with an uncoated surface of a pipe being supported on the pipe support arrangement 2. The guide roller 74 is disposed laterally from the tool head 5b of the scraping tool 5. The distance of the guide roller 74 in relation to the external surface of a pipe being supported on the pipe support arrangement is the same as the distance of the tool head 5b of the scraping tool 5. As illustrated in FIG. 27, the guide roller 74 is configurable to be positioned ahead of the blade 71 of the tool 5 such that the guide roller 74 engages with any deformations on the external surface of a pipe being supported on the pipe support arrangement 2 before the blade 71 engages with the deformation. The guide roller 74 is configurable to be positioned ahead of the blade 71 such that the guide roller is subject to any deformations on the external surface of a pipe being supported on the pipe support arrangement 2 before the blade 71 is subject to the deformation. The guide roller 74 precedes the blade 71 of the scraping tool 5 so that movement of the guide roller 74 due to the contours of a pipe being supported on the pipe support arrangement 2 is followed by the blade 71.

The guide arrangement 72 has an adjustable guide roller arm 76 configured to enable adjustment of the guide roller 74. Adjustment of the height and/or pitch of the guide roller 74 accommodates for different depth requirements based on blade 71 wear of the tool 5 and/or the depth of the coating of a pipe being supported on the pipe support arrangement 2. The adjustable guide roller arm 76 is a telescopic arm. This enables the length of the guide roller arm 76 to be adjusted and therefore enables the position of the guide roller 74 to be adjusted. The adjustable guide roller arm 76 has two or more telescopic members 76a and 76b which are configurable to slide into and out of one another to enable length adjustment of the adjustable guide roller arm 76. Referring to FIG. 27, telescopic member 76b is configurable to slide into and out of telescopic member 76a. The guide arrangement 72 has a link arm 77 for attaching the guide arrangement 72 to the at least one tool (referenced as tool 5 in FIG. 27). The link arm 77 is an adjustable link arm. The link arm 77 is attached to the guide roller arm 76 at one end via a pin 78 and to the tool head 5b at the other end via a pin 79. The adjustable guide roller arm 76 is configured to pivot about the longitudinal axis of the pin 78 attaching it to the guide link arm 77. The guide link arm 77 is configured to pivot around the longitudinal axis of one or both of the pins 78, 79 attaching it to the adjustable guide roller arm 76 and the tool head 5b. Adjustment of the length of the adjustable guide roller arm 76 will cause the adjustable guide roller arm 76 and/or the link arm 77 to pivot around the longitudinal axis of the pin 78 attaching the adjustable guide roller arm 76 to the link arm 77 to accommodate for the length adjustment of the adjustable guide roller arm 76. Adjustment of the length of the adjustable guide roller arm 76 will cause the link arm 77 and/or the tool head 5b to pivot around the longitudinal axis of the pin 79 attaching the link arm 77 to the tool head 5b to accommodate for the length adjustment of the adjustable guide roller arm 76. The guide arrangement 72 has a locking arrangement 86 to prevent undesirable movement of the adjustable guide roller arm 76 and/or undesirable adjustment to the length of the adjustable guide roller arm 76. The guide arrangement 72 has an adjustable guide roller arm clamp 86 to prevent undesirable movement of the adjustable guide roller arm 76 and/or undesirable adjustment to the length of the adjustable guide roller arm 76. The adjustable guide roller arm clamp 86 is configurable to releasably clamp the adjustable guide roller arm 76 in position. The adjustable guide roller arm clamp 86 can be released to enable adjustment of the adjustable guide roller arm 76. The adjustable guide roller arm clamp 86 is a clamp, screw, bolt and/or any other means suitable to releasably fasten to prevent movement of the adjustable guide roller arm 76. The adjustable guide roller arm clamp 86 is a clamp, screw, bolt and/or any other means suitable to releasably fasten to prevent movement of the two or more telescopic members 76a 76b of the adjustable guide roller arm 76. The adjustable guide roller arm clamp 86 is configured to prevent movement of the telescopic member 76b in and/or out of the telescopic member 76a of the adjustable guide roller arm 76. In this embodiment, the clamp arm 86 is a screw configurable to screw into one or more apertures in the telescopic members to prevent movement therebetween. The guide link arm 77 is a turn buckle.

The guide arrangement 72 has a guide chute 75 configured to guide removed pipe coating away from the tool head 5b. In FIG. 27, the guide chute 75 is located behind the tool head 5b. In this embodiment, the guide chute 75 has a deflection surface 75a which engages removed pipe coating and deflects the removed pipe coating away from the tool head 5b and/or away from the tool frame 40. The pipe coating removal apparatus 1 has a shock absorber to absorb any shock from height spots and/or deformations when processing the pipe. The guide arrangement 72 has a shock absorber 103 to absorb any shock from height spots and/or deformations when processing the pipe. The shock absorber 103 is a hydraulic accumulator.

The pipe coating removal apparatus 1 has a cabin 23 (see FIGS. 1, 5 and 6) and a control panel 9, illustrated in FIG. 7, located within the cabin 23. Alternatively, the control panel 9 may be remote from the pipe coating removal apparatus 1 or located at any other suitable part of the pipe coating removal apparatus 1. The cabin 23 has a window 43 to enable vision by the operator. The cabin 23 is located at a level overlooking the pipe support arrangement and the window 43 is located on the side of the cabin 23 that overlooks the pipe support arrangement 2 as the cabin moves along the pipe support arrangement 2. The cabin 23 is located at a level so that the window 43 of the cabin overlooks the pipe support arrangement 2. Locating the control cabin 23 to overlook the pipe support arrangement 2 ensures the section of pipe being operated on is visible to the operator. The cabin 23 mutually opposes the tool carriage 3. The cabin is supported on a platform 92 of the tool carriage structural support frame 90.

The pipe support arrangement 2 has a plurality of spaced apart contact elements 17, illustrated in FIGS. 1, 3 and 13, for contacting the outer surface of a pipe being supported on the pipe support arrangement 2. The pipe support arrangement 2 may have any number of contact elements. The contact elements 17 are moveable towards/away from one another. In the embodiment shown in FIGS. 1, 3, 30 and 37, the contact elements 17 are slidably mounted on rail 50 to enable adjustment of the length over which a pipe can be supported on the pipe support arrangement 2. The loading components have an opening 27 (illustrated in FIG. 13) through which rail 50 extends. The opening is shaped to correspond to the shape of the rail 50. Adjusting of the length over which a pipe can be supported on the pipe support arrangement 2 enables accommodation of different sized pipes. Movement of the contact elements along the rail is via one or more hydraulic cylinders 102, illustrated in FIG. 37.

The contact elements 17 comprise two rotators 15 formed of rubber wheels. In this embodiment, the rotators 15 are forklift wheels. Alternatively, the contact elements may have any number of rotators formed of any suitable material. The rotators 15 of each contact element 17 are fixed to a common drive means to allow simultaneous rotation of the rotators 15. The rotators 15 of each contact element 17 are fixed to a common shaft to allow simultaneous rotation of the rotators 15. In this embodiment, the rotators 15 are driven via an electric motor 28 and gearbox. However, the rotators may also be driven by any other suitable means. The electric motor 28 has an inverter 29 to control variable speed of the rotators 15. In use, the rotators 15 contact the surface of a pipe being supported on the pipe support arrangement 2 and rotate it about its longitudinal axis. This ensures that the entire outer diameter of the pipe is exposed to the pipe coating removal apparatus 1 without manual intervention.

The pipe support arrangement 2 has mini contact elements 21 capable of contacting and supporting lighter pipes. The mini contact elements 21 have two mini rotators 22 lined with a non-damaging material such as rubber, nylon, plastic etc to rotate lighter pipes. In this embodiment, the mini contact elements 21 have hydraulic cylinders 52 to provide power to the rotators 22.

in one embodiment, the pipe coating removal apparatus 1 has an internal rotator 69 to rotate the pipe internally. The internal rotator is illustrated in FIG. 15. The internal rotator 69 is configured to fit inside the pipe. The internal rotator 69 is configured or adjustable to fit inside a variety of pipes having different sized diameters. The internal rotator is configured to lock onto the internal diameter of the pipe or onto an insert on the pipe. The internal rotator 69 enables non frictional rotation of the pipe. In this embodiment, the pipe coating removal apparatus has two internal rotators 69.

The pipe coating removal apparatus 1 has two loading components 13 for loading/unloading a pipe onto/off the pipe coating removal apparatus 1. The loading components 13 are operable to load/unload the pipe onto/off the rotators. In this embodiment, the loading components are movably fixed to the pipe support arrangement 2. The loading components 13 have a receiving portion 30 for receiving and supporting a pipe. The receiving portion 30 has two raised end sections 33 and a dipped middle section 34. The receiving portion 30 has a receiving surface 31, shaped to correspond with the outer diameter of a section of a pipe, which is in contact with the pipe during loading/unloading. The receiving surface 31 has an impact bed runner 32 for absorbing shock from the pipe being loaded. The impact bed runner 32 is composed of shock absorbent materials such as nylon, rubber, or high polymer plastics etc. The impact bed runner 32 reduces vibration and damage to the pipe coating apparatus 1 caused by loading a pipe.

The loading components 13 can be raised and lowered. The pipe coating removal apparatus 1 has an actuator 35 for raising and lowering the loading components 13. The receiving portion 30 is operably connected to the actuator for the raising and lowering the loading component 13. The loading components 13 have hydraulic cylinders 35 which drive the raising and lowering of the loading components 13. In use, the rotators 15 can only rotate when the loading components 13 are in a fully lowered position as shown in FIGS. 1 and 11 and are not being operated. The loading components 13 can only be raised and/or lowered when all of the rotators 15 are not operational. The loading components 13 can only be raised and/or lowered when the tool carriage 3 is in home position. By home position, we mean any position where the tool carriage 3 is located at a position which does not overlap any part of the pipe.

The pipe coating removal apparatus 1 has a restraining arrangement 14 to restrain a pipe on the pipe coating removal apparatus 1. The restraining arrangement 14 is adjustable to support different lengths of pipe. In this embodiment, the restraining arrangement 14 is fixed to the rotators 15. Fixing the restraining arrangement 14 to the rotators 15 enables adjustment of the position of the restraining arrangement 14 for position of different lengths of pipe. The restraining arrangement 14 has an end restraint 37 to prevent end float of the pipe. The restraining arrangement has internal restraints 36 to prevent lift of the pipe away from the pipe support arrangement 2 during rotation of the pipe. The internal restraints 36 are configured to hold down the pipe on the pipe support arrangement 2. The internal restraints 36 are configured to rotate the pipe internally. The end restraints 37 and the internal restraints 36 have abutment elements 38 for contacting the pipe. The abutment elements 38 of the end restraints 37 abut against a pipe being supported on the pipe support arrangement at or about the end of the pipe. The abutment elements 38 on the internal restraints 36 abut against the internal surface of the pipe. In this embodiment, the abutment elements 38 are nylon and/or steel rollers 39. The rollers 39 do not inhibit rotation of pipes. One embodiment of the end restraint 14, as illustrated in FIG. 15, also has the internal rotator 69 mounted thereto. In this embodiment, the head of the end restraint can be twisted to enable the use of the internal rotator for smaller pipes. A second embodiment of the end restraint 14 is illustrated in FIG. 31 and does not have an internal rotator. Embodiments of the end restraint can be used interchangeably.

The pipe coating removal apparatus 1 has an air handling system 10 for controlling circulation of dust and other pollutants resulting from the pipe coating removal process. The air handling system 10 has an extraction unit 45 for extracting air from the tool carriage. In this embodiment, the air handling system 10 has a plurality of suction ducts 46 located within the tool carriage 3. The air handling system has an extraction conduit 47 extending between the extraction unit 45 and the plurality of suction ducts 46. The extraction conduit 47 is a flexible conduit to allow adjustment of the tool frame 40. The extraction conduit 47 is configured to stretch to allow adjustment of the tool frame 40. The air handling system 10 has a plurality of intermediate ducts 47a which extend between the extraction conduit and the plurality of suction ducts 46. In this embodiment, each pipe coating removal tool 4, 5, 6, 7, 8, 80, 81 82 and/or 70 has a suction duct 46 with a suction point at the front and a suction point at the back of each tool. In use, dust and airborne particles are collected via the suction ducts 46 and are transported along the conduit 47 to the extraction unit 45. The extraction unit 45 has a non-return valve 48 to prevent dust and particles returning back into the tool carriage 3. The extraction unit also has a spark arrestor 49 to prevent ignition of the dust particles and chemicals extracted from the pipe coating removal process.

The pipe coating removal apparatus 1 has a waste collection system 11 for collecting waste resulting from the pipe coating removal process. The waste collection system 11 has a conveyor 26 for delivering waste away from the tool carriage 3. Multiple conveyors may be used if desired. In this embodiment, the conveyor 26 of the waste collection system 11 is located beneath the framework 16. Removed pipe coating is guided towards the waste collection system 11 and/or conveyors 26 by the guide chute 75 (illustrated in FIG. 27).

The pipe coating removal apparatus 1 has a visual feedback mechanism. In this embodiment, each of the pipe coating removal tools 4, 5, 6, 7, 8, 80, 81 82 and/or 70 have cameras which feedback to a screen in the cabin 23.

The pipe coating removal apparatus 1 has a cleaning arrangement 68. The pipe coating removal apparatus 1 has at least one cleaning tool for cleaning the pipe. The cleaning arrangement 68 has at least one cleaning tool. In this embodiment, the pipe coating removal apparatus 1 has at least one internal water jet 61 for cleaning the internal surface of the pipe and has at least one internal brush 60 for cleaning the internal surface of the pipe. The pipe coating removal apparatus 1 has a cleaning carriage 63. The cleaning carriage 63 is configured to store cleaning medium. The cleaning carriage 63 has a hopper 64 to store cleaning medium. The cleaning carriage 63 is supported on the pipe support arrangement 2. In this embodiment, the cleaning carriage 63 is moveable along the pipe support arrangement 2. In other embodiments, the cleaning carriage 63 may be static. The cleaning carriage 63 is electrically, hydraulically, or any other way suitably driven. The pipe support arrangement 2 is configurable to move the pipe relative to the cleaning carriage 63. The at least one cleaning tool 60,61 is supportable on a boom 65. The boom 65 extends from the cleaning carriage 63. The pipe coating removal apparatus 1 has an internal support arrangement 66 for supporting the boom 65 inside the pipe. In this embodiment, the internal support arrangement 66 has one or more support wheels 67. The internal support arrangement 66 is adjustable to suit the internal pipe diameter. The cleaning carriage 63 has a control panel for controlling the at least one cleaning tool 60,61, boom 65 and or internal support arrangement 66.

The pipe coating removal apparatus 1 has walkways and ladders 104 for safe access to the various components of the pipe coating removal apparatus 1. This embodiment of the pipe coating removal apparatus has a plurality of automatic and manual stop triggers located at spaced locations around the pipe coating removal apparatus 1. The pipe coating removal apparatus 1 has a fire suppression arrangement 105 such as one or more fire extinguishers 105 (illustrated in FIG. 5), sprinklers and/or any other suitable arrangement.

Referring to the drawings and now to FIG. 38, the overall control system 200 of the pipe coating removal apparatus 1 comprises a hybrid of an electrical system with a hydraulic system described more fully below with reference to the schematic drawing of FIG. 38. The basic requirements of the electrical system for the pipe coating removal apparatus 1 are a stable 3 phase power supply in a range between 100 kw and 1000 Kw and most preferably 400 Kw comprising dedicated earthing. Portable generators 201 are suitable for providing the power requirements or alternatively fixed three phase electrical supplies 201 can be used. The hydraulic system is powered by two separate hydraulic pumps 208 operably coupled to the primary electrical supply source 201.

The pipe coating removal apparatus 1 is controlled primarily through use of a human machine interface (HMI) 204. The HMI 204 itself consists of a LED display surrounded by buttons 205, switches 205 and joysticks 206 and toggle switches 205. The display is capable of moving between different pages or screens which depending on the screen assigns the surrounding buttons to different functions of the pipe coating removal apparatus 1. By cycling through the screens and using the buttons correctly this allow the user to control the pipe coating removal apparatus 1 functions. Some functions on the machine also have a dedicated button 205 on the control panel, or a dedicated joystick 206. Using either of these dedicated controls will also allow use of the relevant function without an action being required on the HMI 204.

When a signal is received from the controls of the HMI 204, this is converted by the built in PLC 207 to produce an output to the relevant hydraulic or electrical system, performing the function of the pipe coating removal apparatus 1 as required by the operator.

The hydraulic system comprises two primary hydraulic pumps 208 which are electrically coupled to the primary electrical power supply 201. The hydraulic pumps 208 provide hydraulic power to hydraulic motors 210 on pipe rotator drives 221 and provides hydraulic fluid to the hydraulic cylinders 35 of the pipe loading components 13 via the HMI 204.

The tool carriage 3 is moved longitudinally along the pipe support arrangement 3 by electric drive motors 96, and can be moved vertically by hydraulic rams 100. The tool frame 40 is raised and lowered by hydraulic rams 100 on either side of the frame. The rams 100 are controlled by a set of buttons on the HMI 204 inside the cabin. The first step for setting up the tool frame 40 is to determine a suitable height for the pipe to be processed. The height of the tool frame 40 is important as it will affect how each tool interacts with the pipe during processing. There is a height guide on the right-hand side when viewed from the cabin of the tool frame 40, allowing the operator to easily adjust the height to the required level, while controlling the hydraulic rams 100 inside the cabin via HMI 204.

The pipe coating removal tools 6, 7, 8, 80, 81, 82 and/or 70 are driven via hydraulic motors 101.

The tools 4, 5, 6, 7, 8, 70, 80, 81, 82 are configured to be raised and/or lowered via a hydraulic and/or pneumatic cylinder 51. The pipe coating removal tools 6, 7, 8, 80, 81, 82 and/or 70 are driven via hydraulic motors 101. The longitudinal scraper 4 is engaged on the pipe with the tool frame at a suitable predetermined height, and at suitable pressure. The carriage is then moved from right to left, so that the cutting edge of the scraper moves through the PE. The cutting edge removes the PE so that a strip is fully removed. The tool frame height and pressure should be constant throughout this movement. The longitudinal scraper is controlled from within the cabin via HMI 204. A toggle switch 205 allows the operator to raise and lower the scraper 4, engaging and disengaging the scraper with the pipe as needed. Once the scraper 4 is engaged on the pipe, the pressure through the tool 4 can be adjusted down or up via the pressure control dial inside the cabin via HMI 204. The pressure is displayed on both the operator interface on the carriage control screen, and a pressure gauge built into the cabin.

The rotational scraper tool 5 is controlled from within the cabin via HMI 204. A toggle switch 205 allows the operator to raise and lower the scraper, engaging and disengaging the scraper with the pipe as needed. Once the scraper is engaged on the pipe, the pressure through the tool can be adjusted down or up via the pressure control dial inside the cabin via HMI 204. The pressure is displayed on both the operator interface on the carriage control screen, and a pressure gauge built into the cabin. During processing, the pressure can be adjusted to account for rises and falls in the pipe.

The longitudinal brushes 6, 7 and 80 are individually controlled from within the cabin via HMI 204. A toggle switch 205 allows the operator to raise and lower the brushes, engaging and disengaging the brushes with the pipe as needed. A 205 switch allows the operator to spin the brushes clockwise or anticlockwise as appropriate.

The transverse brushes 81, 8, 82 are the sixth and seventh tools used during the processing of pipes. The brushes are spun by hydraulic motors 101, spinning at up to 3000 rpm removing FBE from the pipe as the rotation of the pipe and lateral movement of the carriage move the brushes across the pipe. The transverse brushes are individually controlled from within the cabin via HMI 204. A toggle switch 205 allows the operator to raise and lower the brushes, engaging and disengaging the brushes with the pipe as needed. A 205 switch allows the operator to spin the brushes clockwise or anticlockwise as appropriate.

A pneumatic system comprises a compressor 231 electrically coupled to the primary electrical power supply 201 via PCB 207 and provides pneumatic power to the fans 232 of the dust extraction system 241 and the pneumatic cylinders 51 of the tools. The dust extraction hood is controlled from within the cabin via HMI 204. A toggle 205 switch allows the operator to raise and lower the hood, engaging and disengaging the hood with the pipe as needed. Power to the main dust extraction unit 241 is required for the extraction hood to work delivered from main power source 201 via PCB 207.

The safety system of the machine consists of two major systems. The first is the Emergency stop function of the machine. This consists of numerous mushroom head E-Stop buttons 210, E-Stop pull chords 211, Key Activated buttons 212 and safety sensors 213 for access restriction. Activation of any of these E-Stops or breaking of the safety sensor 213 will cause the E-Stop circuit to be activated by way of a safety relay 214. This will cause the machine to immediately stop. The E-Stop circuit will have to be reset along with any activated buttons before the machine is able to be restarted. The Key Activated E-Stop buttons can be pushed then have the key removed, this effectively locks out the machine preventing its use until the key is replaced and the button and circuit is reset.

The second is the machine securities built into the control system 200 which prevents certain actions taking place unless various conditions have been met. This serves to prevent activation of some functions at times when that might be damaging or dangerous. Examples include the restriction of the carriage movement when the Vee Blocks are not in their home position.

In use, an operator enters cabin 23 to control the pipe coating removal apparatus 1 via control panel 9. A pipe is moved onto the loading components 13, by a preloading frame and/or external vehicle for example, and the loading components 13 are operated to lower the pipe onto the rotators 15. The tool carriage 3 is operated to move into position over the pipe. The waste collection system 11 and air handling system 10 are operated. The cutting tool 4 is operated, if and when required, to create a longitudinal cut in the coating along the length of the pipe, prior to the rotation of the rotators 15. The rotators 15 are operated to rotate the pipe when required. The scraping tool 5 is operated, if and when required, to scrape off the coating on the pipe as the pipe is being rotated. Simultaneously or independently, the abrasive tools 6, 7, 8, 80, 81 82 and/or 70 are operated, if and when required, to removed coating on the pipe and create a smooth finish over the pipe as the pipe is being rotated. The tools 5, 6, 7, 8, 80, 81 82 and/or 70 may be operated to remove coating on the pipe at the same time or independently of each other. Once all or some of the coating on the pipe is removed as desired, the tool carriage 3 is moved away from the pipe and the loading components 13 are operated. causing the rotators 15 to stop rotating, and the pipe is raised off the rotators 15 by the loading components 13. Alternatively, the rotators 15 may be prevented from rotating, prior to operating the loading components 13. by the operator in the cabin 23.

In relation to the detailed description of the different embodiments of the invention, it will be understood that one or more technical features of one embodiment can be used in combination with one or more technical features of any other embodiment where the transferred use of the one or more technical features would be immediately apparent to a person of ordinary skill in the art to carry out a similar function in a similar way on the other embodiment.

In the preceding discussion of the invention, unless stated to the contrary, the disclosure of alternative values for the upper or lower limit of the permitted range of a parameter, coupled with an indication that one of the values is more highly preferred than the other, is to be construed as an implied statement that each intermediate value of the parameter, lying between the more preferred and the less preferred of the alternatives, is itself preferred to the less preferred value and also to each value lying between the less preferred value and the intermediate value.

The features disclosed in the foregoing description or the following drawings, expressed in their specific forms or in terms of a means for performing a disclosed function, or a method or a process of attaining the disclosed result, as appropriate, may separately, or in any combination of such features be utilised for realising the invention in diverse forms thereof.

1. A pipe coating removal apparatus for removing all or some of the coating on a pipe, the pipe coating removal apparatus comprising a pipe support means for supporting a length of pipe, and a tool carriage, the tool carriage being capable of supporting two or more different types of pipe coating removal tools, the pipe coating removal apparatus being capable of causing relative movement between the tool carriage and the pipe support means to remove all or some of the coating on the pipe that is supportable by the pipe support means.

2. A pipe coating removal apparatus according to claim 1, wherein the two or more different types of pipe coating removal tools comprises any two of a scraping tool, a cutting tool and/or an abrasive tool.

3. A pipe coating removal apparatus according to any preceding claim, wherein the tool carriage is configurable to support at least eight tools.

4. A pipe coating removal apparatus according to any preceding claim, wherein the tool carriage is moveable along the pipe support means.

5. A pipe coating removal apparatus according to any preceding claim, wherein the pipe coating removal apparatus comprises a longitudinal cutting tool to create a longitudinal cut along the pipe coating of a pipe supportable on the pipe support means.

6. A pipe coating removal apparatus according to claim 5, wherein the longitudinal cutting tool is configurable to work in both longitudinal directions allowing the pipe coating removal tool to operate from either end of a pipe supportable on the pipe support means.

7. A pipe coating removal apparatus according to any preceding claim, wherein the pipe coating removal apparatus comprises a circumferential scraping tool configurable to remove all or some coating on a pipe supportable on the pipe support means.

8. A pipe coating removal apparatus according to any preceding claim, wherein the pipe coating removal apparatus comprises one or more abrasive tools.

9. A pipe coating removal apparatus according to claim 8, wherein the one or more abrasive tools comprise one or more wire brushes and/or one or more flap wheels and/or one or more belt sanders.

10. A pipe coating removal apparatus according to claim 2, 5, 7 or 8 wherein, the cutting tool(s), scraping tool(s) and/or abrasive tool(s) comprise at least one hydraulic and/or pneumatic cylinder configurable to raise and/or lower the cutting tool(s), scraping tools) and/or abrasive tool(s) towards and/or away from a pipe supportable on the pipe support means.

11. A pipe coating removal apparatus according to claim 2, 5, 7, 8 or 10 wherein, the cutting tool(s), scraping tool(s) and/or abrasive tool(s) can be operated independently.

12. A pipe coating removal apparatus according to any preceding claim, wherein each of the two or more tools comprise a tool arm and a tool head extending from the tool arm wherein the tool head is configurable to remove all or some pipe coating from a pipe supportable on the pipe support means.

13. A pipe coating removal apparatus according to any preceding claim wherein, the pipe coating removal apparatus comprises a guide means to guide engagement of at least one of the two or more tools with a surface of a pipe supportable on the pipe support means.

14. A pipe coating removal apparatus according to claim 13, wherein the guide means is releasably attachable to at least one of the two or more tools.

15. A pipe coating removal apparatus according to claims 13 to 14, wherein the guide means comprises a guide roller configurable to engage with the external surface of a pipe supportable on the pipe support means.

16. A pipe coating removal apparatus according to claims 13 to 15, wherein the guide means is configurable to move radially towards and/or away from a pipe supportable on the pipe support means depending on the contour of that pipe.

17. A pipe coating removal apparatus according to claims 13 to 16, wherein the guide means is configurable to cause radial movement of the tool head of the at least one tool towards and/or away from a pipe supportable on the pipe support means.

18. A pipe coating removal apparatus according to claims 13 to 17, wherein the guide means is configurable to adjust the height of the tool head in response to deformations such as welds and/or protrusions on the external surface of a pipe supportable on the pipe support means.

19. A pipe coating removal apparatus according to claims 13 to 18, wherein the guide means is configurable to adjust the height of the tool head in response to deformations such as dents on the external surface of a pipe supportable on the pipe support means.

20. A pipe coating removal apparatus according to claims 13 to 19, wherein the guide means comprises a guide shoot configurable to guide removed pipe coating away from the tool head.

21. A pipe coating removal apparatus according to claim 13 when dependent on claim 7, wherein the at least one circumferential scraping tool comprises a guide means.

22. A pipe coating removal apparatus according to any preceding claim, wherein the pipe coating removal apparatus comprises a control means for controlling one or more components of the pipe coating removal apparatus and a control panel for operating the control means and/or one or more components of the pipe coating removal apparatus.

23. A pipe coating removal apparatus according to claim 22, wherein the pipe coating removal apparatus comprises a cabin for an operator, the cabin comprising a window to enable vision from the cabin.

24. A pipe coating removal apparatus according to claim 23, wherein the cabin is locatable at a level such that the window is overlooking the pipe support means.

25. A pipe coating removal apparatus according to any preceding claim, wherein the pipe coating removal apparatus is configurable to remove all or some of the coating on pipe with a single pass of the tool carriage relative to the pipe support means.

26. A pipe coating removal apparatus according to any preceding claim, wherein the pipe support means comprises at least one contact element for contacting the surface of a pipe supportable on the pipe support means.

27. A pipe coating removal apparatus according to claim 26, wherein the pipe support means has two or more longitudinally spaced apart contact elements and wherein the two or more contact elements are moveable towards/away from one another to enable adjustment of the length over which a pipe is supportable on the pipe support means.

28. A pipe coating removal apparatus according to claim 27, wherein each of the two or more contact elements comprise two or more rotators for rotating the pipe, the two or more rotators operably coupled to a common drive means and/or shaft.

29. A pipe coating removal apparatus according to any preceding claim, wherein the pipe support means comprises two or more longitudinally spaced apart mini contact elements capable of contacting and supporting lighter pipes.

30. A pipe coating removal apparatus according to claim 29, wherein each of the two or more mini contact elements comprise at least one mini rotator to rotate lighter pipes.

31. A pipe coating removal apparatus according to any preceding claim, wherein the pipe coating removal apparatus comprises a loading means for loading/unloading a pipe onto/off the pipe support means and/or onto/off the two or more rotators.

32. A pipe coating removal apparatus according to claim 31, wherein the loading means comprises at least one loading component having a receiving portion suitable for receiving and supporting a pipe, the receiving portion having a receiving surface which is contactable with a pipe during loading/unloading of the pipe.

33. A pipe coating removal apparatus according to claim 32, wherein the receiving surface is shaped to accommodate the outer diameter of a section of a pipe.

34. A pipe coating removal apparatus according to claims 31 to 33, wherein the pipe coating removal apparatus comprises an actuator for raising and/or lowering the at least one loading component.

35. A pipe coating removal apparatus according to claims 32 to 34, wherein the receiving portion is operably connected to the actuator for the raising and/or lowering of the at least one loading component.

36. A pipe coating removal apparatus according to claims 28 and 32, wherein the two or more rotators can only rotate when the at least one loading component is in a fully lowered position and is not being operated and/or the at least one loading component can only be raised and/or lowered when all rotators are not operational.

37. A pipe coating removal apparatus according to any preceding claim, wherein the pipe coating removal apparatus comprises a restraining means to restrain a pipe on the pipe support means, the restraining means being configurable to engage with one or both ends of a pipe to maintain the pipe at a predetermined position on the pipe support means.

38. A pipe coating removal apparatus according to claim 37 when dependent on claim 26, wherein the restraining means is fixed to the at least one contact element.

39. A pipe coating removal apparatus according to claims 37 to 38, wherein the restraining means comprises one or more end restraints to prevent end float of a pipe and/or one or more internal restraints configurable to hold a pipe down on the pipe support means.

40. A pipe coating removal apparatus according to any preceding claim, wherein the pipe coating removal apparatus comprises one or more sensors for ensuring a desired amount of pipe coating is removed.

41. A pipe coating removal apparatus according to any preceding claim, wherein at least one of the two or more pipe coating removal tools have associated pressure sensors.

42. A pipe coating removal apparatus according to any preceding claim, wherein the pipe coating removal apparatus comprises a visual feedback mechanism to observe operation of the two or more pipe coating removal tools.

43. A pipe coating removal apparatus according to any preceding claim, wherein the pipe coating removal apparatus comprises an air handling system for controlling circulation of dust and/or other pollutants resulting from the pipe coating removal process.

44. A pipe coating removal apparatus according to claim 43, wherein the air handling system comprises an extraction unit for extracting air from the tool carriage, at least one suction duct located within the tool carriage and at least one extraction conduit extending between the extraction unit and at least one suction duct.

45. A pipe coating removal apparatus according to any preceding claim, wherein the pipe coating removal apparatus comprises a waste collection system for collecting waste resulting from the pipe coating removal process, the waste collection system having one or more conveyors for delivering waste away from the tool carriage and/or for carrying the waste to a hopper.

46. A pipe coating removal apparatus according to claim 45, wherein the waste collection system comprises a shredder for reducing the size of waste coating.

47. A pipe coating removal apparatus according to any preceding claim, wherein the pipe coating removal apparatus comprises a cleaning carriage having at least one water jet for cleaning the pipe and/or at least one internal water jet for cleaning the internal surface of the pipe, at least one internal brush for cleaning the internal surface of the pipe and wherein the cleaning carriage is configurable to store cleaning medium.

48. A pipe coating removal apparatus according to any preceding claim, wherein the pipe coating removal apparatus is modular such that it is configurable to be dismantled and/or compacted for relocation.

49. A method of removing pipe coating from a pipe, the method comprising the step of operating a pipe coating removal apparatus as claimed in any one of claims 1 to 48 for removing all or some coating on a pipe, the method comprising the step of operating a loading means of the pipe coating removal apparatus to load the pipe onto the pipe support means and operating the tool carriage to bring it into position over the pipe, the method then comprising the step of bringing the relevant pipe coating removal tool(s) into engagement with the coating on the pipe, activating the air handling system to extract dust particles from the pipe coating removal apparatus and tool carriage, operating the waste collection system to catch and remove waste coating and debris away from the pipe coating removal apparatus and tool carriage, operating the cutting tool to create a longitudinal cut in the coating along the length of a pipe supportable on the pipe coating removal apparatus, operating two or more rotator(s) to rotate the pipe when required, and simultaneously or independently operating the scraping tool and the one or more abrasive tools to remove all or some of the coating on the pipe, the method further comprising the step of bringing the pipe coating removal tool(s) and tool carriage out of engagement with and away from the pipe and operating the loading means to trigger sensors disconnecting the drive means to the rotator(s) and to safely unload the pipe from the pipe coating removal apparatus.
